(19) United States
(12) Patent Application Publication
(10) Pub. No.: US 2011/0144905 A1
(43) Pub. Date: Jun. 16, 2011

(54) COMMUNICATION ENVIRONMENT PREDICTION TERMINAL, COMMUNICATION ENVIRONMENT PREDICTION METHOD AND COMMUNICATION ENVIRONMENT PREDICTION PROGRAM

(75) Inventor: Kazushi Tahara, Saitama (JP)

(73) Assignee: PIONEER CORPORATION, Kanagawa (JP)

(21) Appl. No.: 13/000,901

(22) PCT Filed: Jun. 26, 2008
(86) PCT No.: PCT/JP2008/061642

§ 371 Date: Feb. 9, 2011

(51) Int. Cl. H04W 64/00; G01C 21/00

(52) U.S. Cl. 701/201; 455/456.1

(57) ABSTRACT

A signal receiving element of a communication environment prediction terminal receives GPS signals via satellite communication from GPS satellites. A position information detecting element detects position information indicating a position of a vehicle on which the terminal is mounted, based on the GPS signals received by the receiving element. Then, a position measurement information generating element generates position measurement information including the position information detected by the detecting element, that is, the position measurement information indicating a travel position of the vehicle positioned by the GPS signals. A communication information generating element generates communication information indicating a communication environment in an area to which the vehicle has moved, based on the position measurement information by making use of the characteristic that the GPS signal is difficult to receive in a point with an obstacle or the like.

### TECHNICAL FIELD

The present invention relates to a method of predicting communication environment in a certain area based on a GPS signal.

### BACKGROUND TECHNIQUE

A car navigation system measures a current vehicle position during traveling by using GPS (Global Positioning System) satellites. Recently, there has been established a system of storing the position measurement information (traveling history) in a storage medium (HDD, etc.) in a car navigation system and uploading the measured information to a server on a network by using the Internet some other day, and such a system is used for various services. In addition, the services of ITS (Intelligent Transport Systems) and Car Telematics have started, and it becomes possible to directly connect with the Internet from the traveling vehicle. If the car navigation system has a function to directly connect with the Internet, it is possible to upload the position measurement information to the server on the real-time basis.

The car navigation system in the early days performs the position measurement only using the GPS satellites, its positioning accuracy was problematic. This is because the car navigation system cannot receive the GPS signals due to the obstacles when traveling in a tunnel or under an overhead bridge. In order to solve this problem, at present, the stand-alone measurement becomes possible by using a geomagnetism sensor and a vehicle speed pulse sensor.

In these days, a memory player is broadly used, and enormous contents can be easily carried. A lot of portable players capable of handling video are on the market, and there has been established an environment in which a user can access the Internet at a hot-spot using a wireless LAN to easily enjoy video contents. Further, such a new style is becoming popular that the user converts the video contents of his or her own into the data format for the portable player to carry and enjoy them at anytime and anywhere when going out.

As described above, there has been established an environment to easily carry enormous contents. However, in order to carry the contents, the compression processing of the contents must be done. Normally, the compression processing of music is completed in a relatively short time, but the compression processing of video requires a considerable time. Since the video contents do not fit with the style of repeatedly watching and listening, the troublesomeness is the problem. In order to overcome this problem, there is proposed a method of watching and listening to the video contents recorded on the HDD recorder by using the streaming technique. By using the streaming technique, it is possible to enjoy the video contents even in a traveling vehicle if the vehicle can directly access the Internet. However, since the traveling vehicle sometimes passes the place where the obstacle such as the tunnel exists, the reproduced video is stopped depending upon the passing place of the vehicle only by the conventional streaming technique.

As a method of overcoming such a problem, the Patent Reference 1 discloses detecting the state of the communication environment from the communication environment material. Also, the Patent Reference 2 is known as the method of generating the communication environment material. However, these conventional methods need to introduce a huge facility, and the application to the moving vehicle is not advisable.

### Patent Reference 1:

Japanese Patent Application Laid-open under No. 2006-173973

### Patent Reference 2:

Japanese Patent Application Laid-open under No. 2000-78092

### DISCLOSURE OF INVENTION

### Problem to be Solved by the Invention

The above is one of the problems to be solved by the present invention. It is an object of the present invention to provide a communication environment prediction terminal which predicts communication environment in an area to which the communication environment prediction terminal moves, by utilizing the characteristic that the GPS signals cannot be received in a place where the obstacle exists.

### Means for Solving the Problem

The invention of claim 1 is a communication environment prediction terminal loaded on a vehicle, comprising: a signal receiving means which receives GPS signals from GPS satellites by using satellite communication; a position information detecting means which detects position information indicating a position of the vehicle based on the GPS signals; a position measurement information generating means which generates a position measurement information including the position information; and a communication information generating means which generates communication information indicating communication environment in an area to which the vehicle moves, based on the position measurement information.

The invention of claim 7 is a communication environment prediction method executed by a communication environment prediction terminal loaded on a vehicle, comprising: a signal receiving process which receives GPS signals from GPS satellites by using satellite communication; a position information detecting process which detects position information indicating a position of the vehicle based on the GPS signals; a position measurement information generating process which generates a position measurement information including the position information; and a communication information generating process which generates communication information indicating communication environment in an area to which the vehicle moves, based on the position measurement information.

The invention of claim 8 is a communication environment prediction program executed by a computer loaded on a vehicle, making the computer to function as: a signal receiving means which receives GPS signals from GPS satellites by using satellite communication; a position information detecting means which detects position information indicating a position of the vehicle based on the GPS signals; a position measurement information generating means which generates a position measurement information including the position information; and a communication information generating means which generates communication information indicating communication environment in an area to which the vehicle moves, based on the position measurement information.

The invention of claim 10 is a communication environment prediction server capable of communicating with communication environment prediction terminals loaded on plural vehicles, respectively, comprising: a position measurement information obtaining means which obtains, from the communication environment prediction terminal, position measurement information including position information indicating a position of the vehicle detected based on GPS signals; and a communication information generating means which generates communication information indicating communication environment in an area to which the vehicle moves, based on the position measurement information.

The invention of claim 11 is a communication environment prediction system comprising communication environment prediction terminals respectively loaded on plural vehicles, and a communication environment prediction server which performs process based on information obtained from the communication environment prediction terminals, the communication environment prediction terminals and the communication environment prediction server capable of communicating with each other, wherein the communication environment prediction terminal comprises: a signal receiving means which receives GPS signals from GPS satellites by using satellite communication; a position information detecting means which detects position information indicating a position of the vehicle based on the GPS signals; a position measurement information generating means which generates a position measurement information including the position information; and a communication information generating means which generates communication information indicating communication environment in an area to which the vehicle moves, based on the position measurement information, and wherein the communication environment prediction server comprises: a communication information obtaining means which obtains the communication information from the plural communication environment prediction terminals; and a prediction information generating means which generates prediction information predicting the communication environment in a predetermined area, based on the plural communication information obtained by the communication information obtaining means.

The invention of claim 12 is a data generating method comprising: a signal receiving process which receives GPS signals from GPS satellites by using satellite communication; a position information detecting process which detects position information of a specific area based on the GPS signals; a position measurement information generating process which generates position measurement information including the position information; and a data generating process which predicts the communication environment in the specific area and generates data indicating the communication environment for each area.

### BRIEF DESCRIPTION OF THE DRAWINGS

FIG. 1 shows an entire configuration of a communication environment prediction system.

FIG. 2 shows an entire configuration of a communication environment prediction system in a case that a navigation device has a communication function.

FIG. 3 is a block diagram showing a configuration of a navigation device.

FIG. 4 is a diagram showing data structure of route calculation purpose information.

FIG. 5 is a diagram showing data structure of node data.

FIGS. 6A and 6B show examples of nodes and links.

FIG. 7 is a block diagram showing a functional configuration of a first communication environment prediction unit.

FIGS. 8A and 8B show data structure of position measurement information.

FIG. 9 shows data structure of communication information A.

FIG. 10 shows data structure of communication information B.

FIG. 11 shows data structure of communication information C.

FIG. 12 is a diagram for explaining receiving interval of GPS signals.

FIG. 13 is a flowchart of a first communication information generating process.

FIG. 14 is a flowchart of a second communication information generating process.

FIG. 15 is a block diagram showing a functional configuration of a second communication environment prediction unit.

FIG. 16 is a block diagram showing a functional configuration of a third communication environment prediction unit.

FIG. 17 is a block diagram showing a functional configuration of a fourth communication environment prediction unit.

FIG. 18 shows a system configuration for realizing navigation using a mobile phone.

### DESCRIPTION OF REFERENCE NUMBERS

2 Network
200 First Communication Prediction Unit
201 Signal Receiving Unit
202 Position Information Detecting Unit
203 Map Information Storage Unit
204 Navigation Processing Unit
205 Traveling History Generating Unit
206 Storage Unit
207 Communication Control Unit
208 Communication Unit
209 AV Reproduction Unit

### MOST PREFERRED FORM TO EXERCISE THE INVENTION

According to one aspect of the present invention, there is provided a communication environment prediction terminal loaded on a vehicle, comprising: a signal receiving means which receives GPS signals from GPS satellites by using satellite communication; a position information detecting means which detects position information indicating a position of the vehicle based on the GPS signals; a position measurement information generating means which generates a position measurement information including the position information; and a communication information generating means which generates communication information indicating communication environment in an area to which the vehicle moves, based on the position measurement information.

The communication environment prediction terminal configured as described above is a car navigation device or a PND (Portable Navigation Device), for example. The signal receiving means of the communication environment prediction terminal receives the GPS signals from the GPS satellites by using the satellite communication. Then, the position information detecting means detects the position information indicating the position of the vehicle loaded with the communication environment prediction terminal, based on the GPS signals received by the signal receiving means. Subsequently, the position measurement information generating means generates position measurement information including the position information, i.e., the position measurement information indicating the traveling position of the vehicle, measured based on the GPS signals. Then, the communication information generating means generates the communication information indicating communication environment in the area to which the vehicle moves, based on the position measurement information, by making the use of the characteristic that the GPS signal is difficult to receive in a point with an obstacle or the like. The communication information thus generated can be used by the communication environment prediction terminal for a stable communication control.

In one mode of the above communication environment prediction terminal, the position measurement information includes a receiving time of the GPS signals and the position information of the vehicle based on the GPS signals, corresponded with each other. By this, the communication information generating means can specify the time when the GPS signal is not being received, based on the position measurement information. Further, based on the time when the GPS signal is not being received, the communication information generating means can specify the vehicle position at that time. Therefore, the communication information generating means can presume that the communication environment is bad at the vehicle position at the time when the GPS signal is not being received, based on the position measurement information.

In another mode of the communication environment prediction terminal, the position measurement information includes a receiving satellite number which is a number of the GPS satellites from which the GPS signals are received, and the position information of the vehicle based on the GPS signals, corresponded with each other, and the communication information generating means generates the communication information indicating that the communication environment is good at a point specified by the position information whose receiving satellite number is large and the communication environment is bad at the point specified by the position information whose receiving satellite number is small, based on the position measurement information. By this, the communication information generating means can presume the communication environment of the specific point based on the receiving satellite number included in the position measurement information.

In still another mode of the communication environment prediction terminal, the communication information is corresponded with type information relating to a type of the communication environment prediction terminal. By this, when a certain server predicts the communication environment in the area to which the vehicle moves based on plural communication information, it can consider the type information included in the communication information. Since the accuracy of specifying the vehicle position differs dependently upon the type of the communication environment prediction terminal received the GPS signals, the prediction accuracy of the communication environment can be improved by considering the type information.

In still another mode of the communication environment prediction terminal, the communication information generating means comprises: an interrupted point setting means which sets a point, specified by the position information whose receiving satellite number is zero, to a communication interrupted point; and an interrupted section setting means which sets successive communication interrupted points to a communication interrupted section, and the communication information generating means generates the communication information based on information relating to the communication interrupted point and the communication interrupted section.

In the communication environment prediction terminal configured as described above, the interrupted point setting means sets a point, specified by the position information whose receiving satellite number is zero, to a communication interrupted point. Then, the interrupted section setting means sets successive communication interrupted points to a communication interrupted section. The communication information generating means generates the communication information based on information relating to the communication interrupted point and the communication interrupted section. By this, since the communication information includes, in advance, information relating to the point and/or the section where the communication is impossible, the communication environment prediction terminal can contrive obtaining the video contents before the point and/or the section where the communication is impossible, based on the communication information, and thus the communication information can be used for the stable communication control.

Still another mode of the communication environment prediction terminal further comprises: a map information storage means which stores map information; a traveling route calculating means which calculates a traveling route of the vehicle based on the position information and the map information; and a communication interrupted route information generating means which specifies a communication interrupted route by comparing the traveling route with the communication interrupted section and which is related to the communication interrupted route, wherein the communication information generating means generates the communication information based on the position measurement information and the communication interrupted route information.

In the communication environment prediction terminal configured as described above, the traveling route calculating means calculates a traveling route of the vehicle based on the position information detected by the position information detecting means and the map information stored in the map information storage means. The communication interrupted route information generating means specifies the communication interrupted route by comparing the calculated traveling route with the communication interrupted section set by the communication interrupted section setting means, and generates the communication interrupted route information relating to the communication interrupted route. Since the communication interrupted route information specifies the communication interrupted route by matching the traveling route and the communication interrupted section, it is more accurate than the communication interrupted section. Therefore, the communication information generating means can generate the communication information with high accuracy based on the position measurement information and the communication interrupted route information.

According to another aspect of the present invention, there is provided a communication environment prediction method executed by a communication environment prediction terminal loaded on a vehicle, comprising: a signal receiving process which receives GPS signals from GPS satellites by using satellite communication; a position information detecting process which detects position information indicating a position of the vehicle based on the GPS signals; a position measurement information generating process which generates a position measurement information including the position information; and a communication information generating process which generates communication information indicating communication environment in an area to which the vehicle moves, based on the position measurement information. By the communication environment prediction method described above, the communication information indicating the communication environment in the area to which the vehicle moves can be generated and used for the stable communication control.

According to still another aspect of the present invention, there is provided a communication environment prediction program executed by a computer loaded on a vehicle, making the computer to function as: a signal receiving means which receives GPS signals from GPS satellites by using satellite communication; a position information detecting means which detects position information indicating a position of the vehicle based on the GPS signals; a position measurement information generating means which generates a position measurement information including the position information; and a communication information generating means which generates communication information indicating communication environment in an area to which the vehicle moves, based on the position measurement information. By executing the above communication environment prediction program on the computer, the communication information indicating the communication environment in the area to which the vehicle moves can be generated and used for the stable communication control.

According to still another aspect of the present invention, there is provided a communication environment prediction server capable of communicating with communication environment prediction terminals loaded on plural vehicles, respectively, comprising: a position measurement information obtaining means which obtains, from the communication environment prediction terminal, position measurement information including position information indicating a position of the vehicle detected based on GPS signals; and a communication information generating means which generates communication information indicating communication environment in an area to which the vehicle moves, based on the position measurement information.

In the communication environment prediction server configured as described above, the position measurement information obtaining means obtains position measurement information including position information indicating a position of the vehicle that the communication environment prediction terminal detects based on GPS signals. The communication information generating means generates communication information indicating communication environment in an area to which the vehicle moves, based on the position measurement information obtained from the communication environment prediction terminal. The communication information thus generated can be used for the stable communication control by the communication environment prediction terminal, for example.

According to still another aspect of the present invention, there is provided communication environment prediction system comprising communication environment prediction terminals respectively loaded on plural vehicles, and a communication environment prediction server which performs process based on information obtained from the communication environment prediction terminals, the communication environment prediction terminals and the communication environment prediction server capable of communicating with each other, wherein the communication environment prediction terminal comprises: a signal receiving means which receives GPS signals from GPS satellites by using satellite communication; a position information detecting means which detects position information indicating a position of the vehicle based on the GPS signals; a position measurement information generating means which generates a position measurement information including the position information; and a communication information generating means which generates communication information indicating communication environment in an area to which the vehicle moves, based on the position measurement information, and wherein the communication environment prediction server comprises: a communication information obtaining means which obtains the communication information from the plural communication environment prediction terminals; and a prediction information generating means which generates prediction information predicting the communication environment in a predetermined area, based on the plural communication information obtained by the communication information obtaining means. By this, the communication environment prediction server can generate the prediction information based on the plural communication information obtained from the plural communication environment prediction servers. Therefore, it is possible to generate the prediction information with high accuracy.

According to still another aspect of the present invention, there is provided a data generating method comprising: a signal receiving process which receives GPS signals from GPS satellites by using satellite communication; a position information detecting process which detects position information of a specific area based on the GPS signals; a position measurement information generating process which generates position measurement information including the position information; and a data generating process which predicts the communication environment in the specific area and generates data indicating the communication environment for each area. The data thus generated can be used for performing the stable communication control.

One mode of the above data generating method includes a predicting process which predicts the communication environment between areas from the data generated by the data generating process. By this, the communication environment in the area not supplemented can be predicted from the generated data.

### EMBODIMENTS

Preferred embodiments of the present invention will be described below with reference to the attached drawings. The following description is directed to the example in which the present invention is applied to an on-vehicle navigation device.

[Basic Configuration]

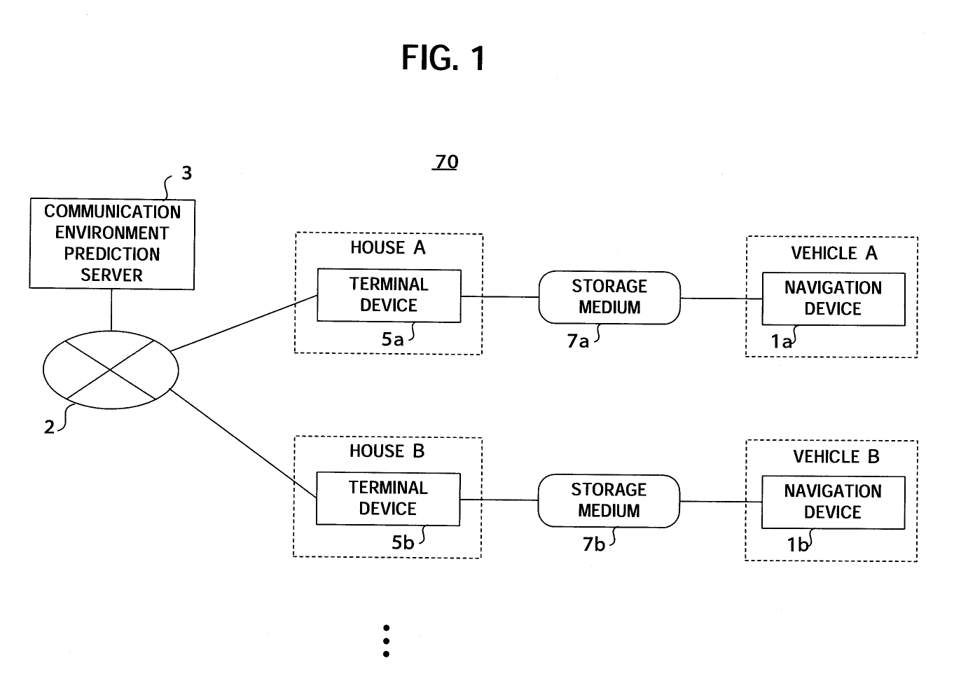

FIG. 1 shows an entire configuration of a communication environment prediction system according to the embodiment of the present invention in a case that the navigation device does not have a communication function. As shown, the communication environment prediction system 70 is a system capable of generating communication information, indicating communication environment in an area to which the vehicle loaded with the navigation device 1 moves, based on the GPS signals. It is noted that the navigation device 1 in the communication environment prediction system 70 does not have a communication function with the network 2.

In this embodiment, the communication environment prediction system 70 includes a communication environment prediction server 3 and plural terminals 5 connected with each other via the network 2 in a manner to communicate with each other. A preferred example of the network 2 is the Internet. The user removes a storage medium 7 of the navigation device 1 loaded on the vehicle, and transmits and receives certain information with the communication environment prediction server 3 arranged on the network 2 by using the terminal device 5 arranged in the house. The terminal device 5 is a PC (Personal Computer) having a communication function with the network 2.

Specifically, the user A removes the storage medium 7a of the navigation device 1a loaded on the vehicle A, and uploads the communication information to the communication environment prediction server 3 by using the terminal device 5a arranged in the house A. The terminal device 5a can download certain information from the communication environment prediction server 3 at the same time. The user B removes the storage medium 7b of the navigation device 1b loaded on the vehicle B, and uploads the communication information to the communication environment prediction server 3 by using the terminal device 5b arranged in the house B. The terminal device 5b can download certain information from the communication environment prediction server 3 at the same time.

The communication information is the information that indicates the communication environment in the area to which the vehicle moves and that is generated by the navigation device 1. Namely, the communication information generated by the navigation device 1 is stored in the storage medium 7 first, and then uploaded to the communication environment prediction server 3 via the terminal device 5. In other words, the communication environment prediction server 3 can obtain the communication information generated by the navigation device 5 from plural terminal devices 5 via the network 2. The communication environment prediction server 3 can generate a communication environment prediction map predicting the communication environment in certain areas based on the plural communication information and provide it to each of the terminal devices 5. The user can store the communication environment prediction map downloaded by the terminal device 5 from the communication environment prediction server 3 into the storage medium 7 and can use it in the navigation device 1.

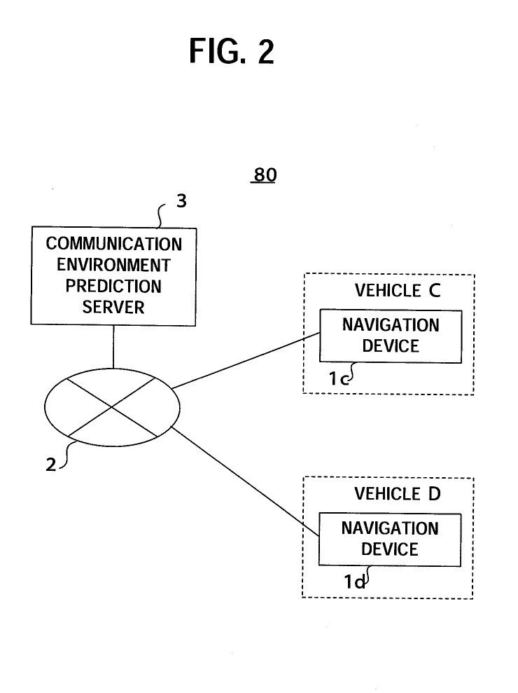

On the other hand, FIG. 2 shows an entire configuration of the communication environment prediction system of the embodiment of the present invention in a case that the navigation device has a communication function. As shown, the communication environment prediction system 80 is a system capable of generating communication information, indicating the communication environment in an area to which the vehicle loaded with the navigation device 1 moves, based on the GPS signals. The navigation device 1 in the communication environment prediction system 80 has a communication function to the network 2.

In this embodiment, the communication environment prediction system 80 includes the communication environment prediction server 3 and plural navigation devices 1 directly connected via the network 2 in a manner to communicate with each other. By this, the communication environment prediction server 3 can directly obtain the communication information from plural navigation devices 1c and 1d via the network 2. Further, the communication environment prediction server 3 can directly provide the communication environment prediction map generated based on the plural communication information to the plural navigation devices 1c and 1d via the network 2.

[Navigation Device]

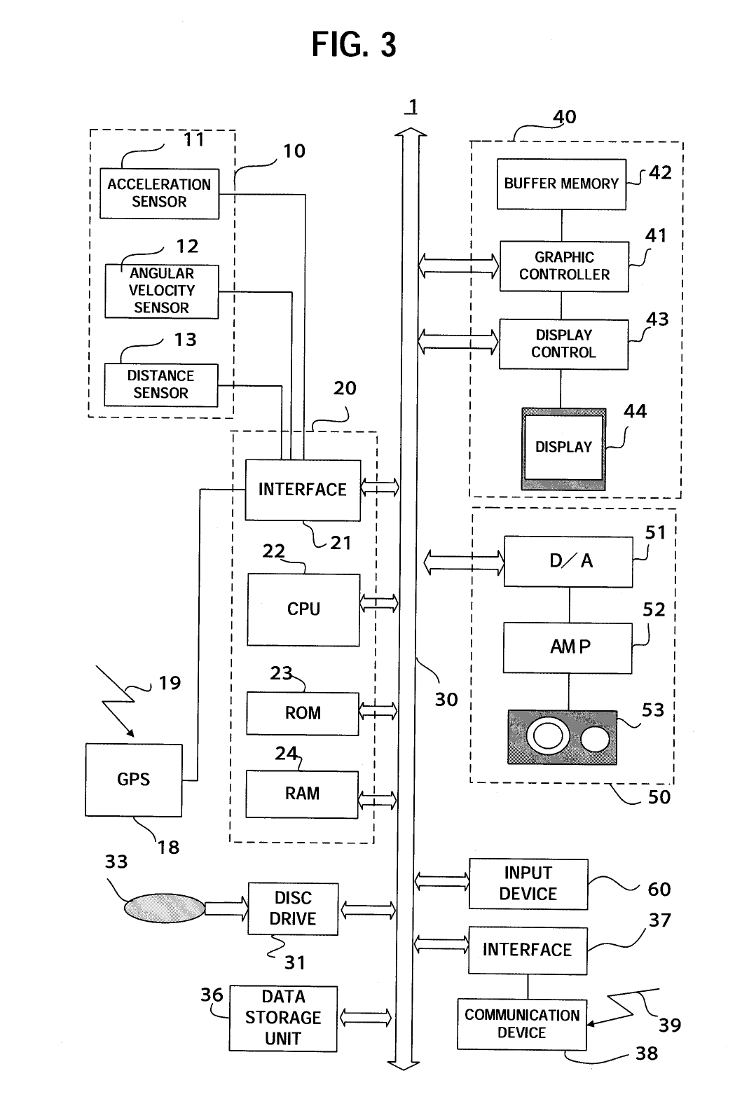

FIG. 3 shows a configuration of the navigation device 1. As shown in FIG. 3, the navigation device 1 includes a stand-alone position measurement device 10, a GPS receiver 18, a system controller 20, a disc drive 31, a data storage unit 36, a communication interface 37, a communication device 38, a display unit 40, a sound output unit 50 and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including pulse signals generated by the wheel rotation of the vehicle.

The GPS receiver 18 receives an electric wave 19 for transmitting downlink data including position measurement data from plural GPS satellites. The position measurement data is used for detecting the absolute position of the vehicle from longitude and latitude information.

The system controller 20 includes an interface 21, a CPU 22, a ROM (Read Only Memory) 23 and a RAM (Random Access Memory) 24, and controls the entire navigation device 1.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and provides a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected with each other via a bus line 30.

Under the control of the system controller 20, the disc drive 31 reads contents data such as sound data and picture data from the disc 33 such as a CD and a DVD to output the contents data. The disc drive 31 may be the CD-ROM drive or the DVD-ROM drive, or may be a drive compatible between the CD and the DVD.

The data storage unit 36 includes HDD, for example, and stores various kinds of data used for a navigation process such as map information and voice data. The above-mentioned storage medium 7 is constituted by the data storage unit 36.

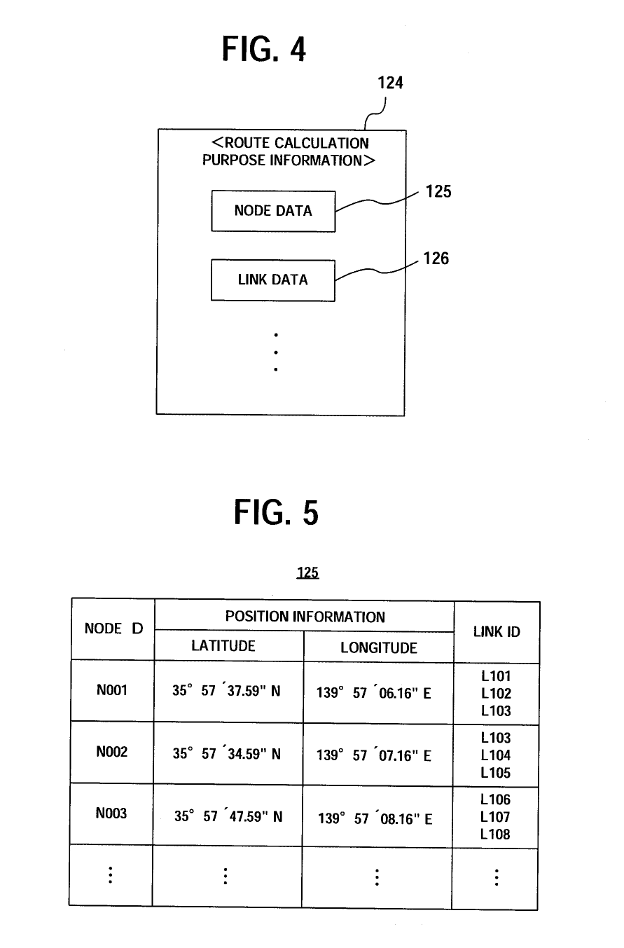

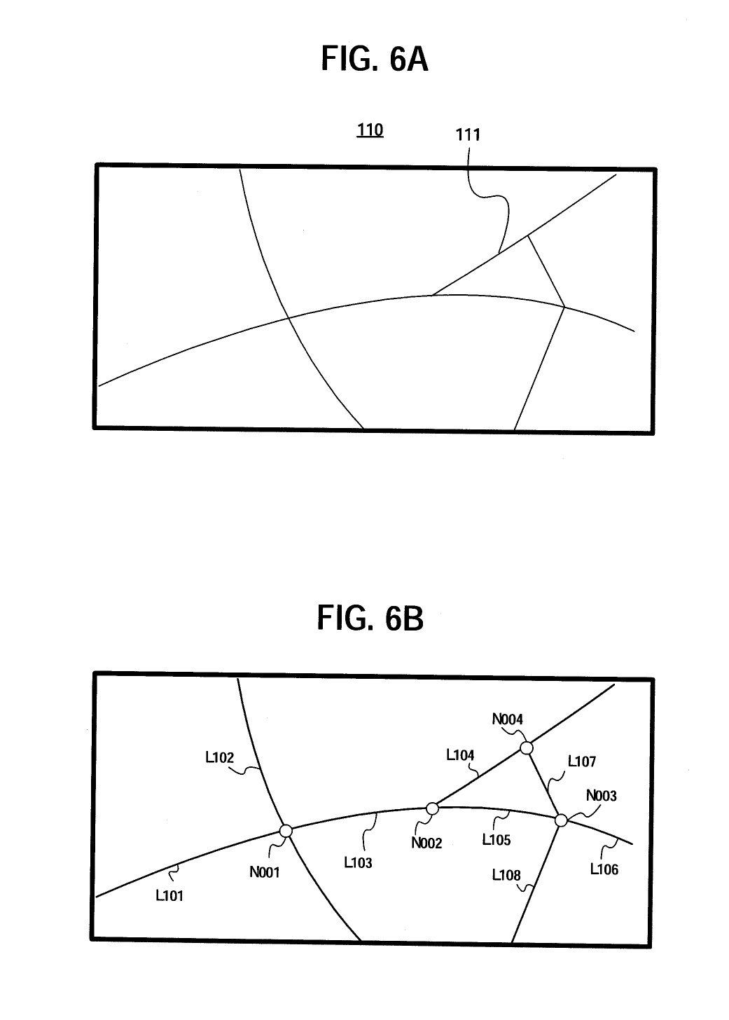

Here, the map information will be described in detail. The map information includes position information (latitude and longitude), map background information, shape data such as roads, and route calculation purpose information. The route calculation purpose information is used in the route calculation when the traveling route of the vehicle is calculated. The route calculation purpose information will be described in more detail by referring to FIGS. 4 to 6. FIG. 4 is a diagram showing the data structure of the route calculation purpose information, FIG. 5 is a diagram showing the data structure of the node data, and FIGS. 6A and 6B show the examples of the nodes and the links.

As shown in FIG. 4, the route calculation purpose information 124 includes the node data 125 and the link data 126. The node corresponds to the predetermined point such as the intersection, and the node data 125 indicates the node and the link including the node. The link corresponds to one segment of the road divided by the intersections, and the link data 126 indicates the link. In this embodiment, it is assumed that the ends of the link are the nodes.

The examples of the nodes and the links are shown in FIGS. 6A and 6B. The map including the plural roads 111 shown in FIG. 6A is formed by the plural nodes and links as shown in FIG. 6B. In FIG. 6B, each node is expressed by the node ID (N0001, etc.), and each link is expressed by the link ID (L101, etc.). FIG. 5 shows the structure of the node data 125. The node data 125 includes the position information (e.g., latitude and longitude) indicating a geographical position for each node ID identifying each node, and the link IDs identifying the links whose end corresponds to the node. The link data 126 includes the distance of the links, the position information indicating the geographical position on the link, information associating the position information on the link with the prefecture, and information indicating whether or not the road corresponding to the link is the toll road, for example.

The communication device 38 includes an FM tuner, a beacon receiver, a mobile phone and a dedicated communication card, for example, and receives, via the communication interface 37, various kinds of information including road traffic information such as the traffic jam and the traffic information distributed by the VICS (Vehicle Information Communication System) center and other information. The communication device 38 may be able to directly connect with the network 2.

The display unit 40 displays various kinds of display data on a display device such as a display under the control of the system controller 20. Concretely, the system controller 20 reads the map data from the data storage unit 36. The display unit 40 displays, on a display screen such as a display, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 for temporarily storing image information having a memory such as a VRAM (Video RAM) and immediately displayable, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A conversion of the sound digital data transmitted from the disc drive 31 or the RAM 24 via the bus line 30 under the control of the system controller 20, an amplifier (AMP) 52 for amplifying an audio analog signal outputted from the D/A converter 51, and a speaker 53 for converting the amplified audio analog signal into the sound and outputting it to the vehicle compartment.

The input device 60 includes keys, switches, buttons, a remote controller and an audio input device, which are used for inputting various kinds of commands and data. The input device 60 is arranged in the vicinity of a front panel of a main body and the display 44 of an on-vehicle electric system loaded on the vehicle. Additionally, in such a case that the display 44 is of a touch panel system, a touch panel provided on the display screen of the display 44 functions as the input device 60, too.

### 1st Embodiment

### (i) 1st Communication Environment Prediction Unit

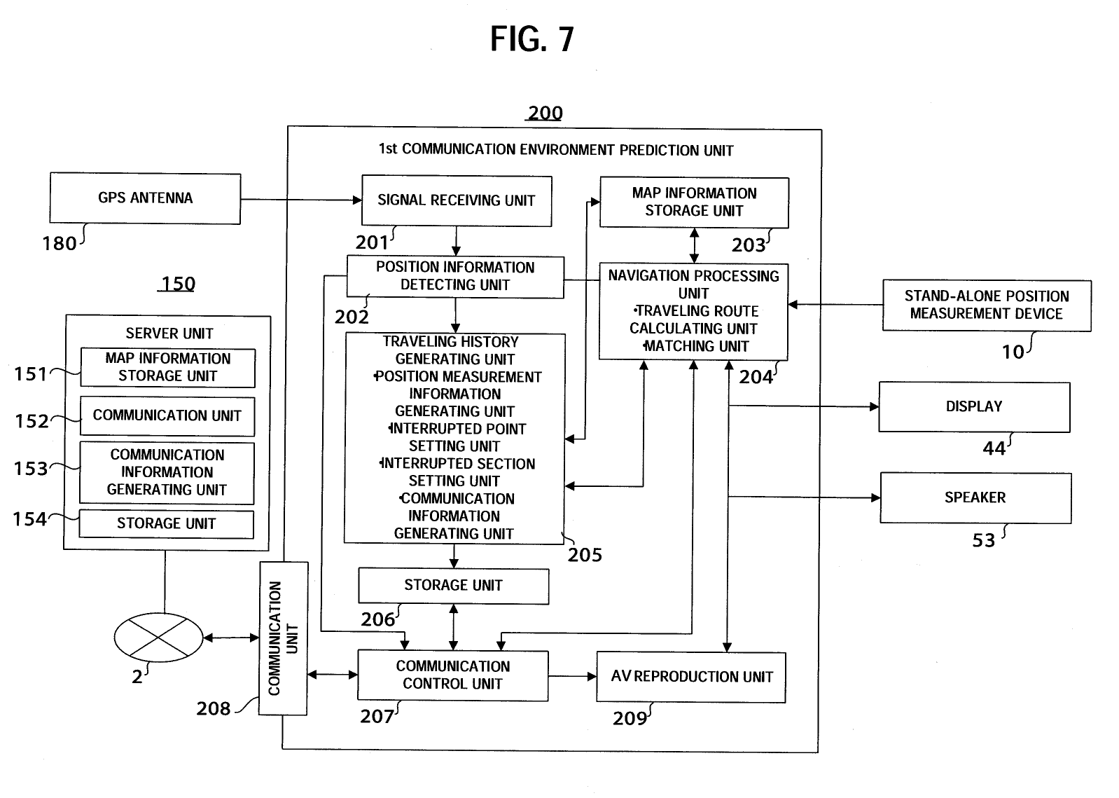

FIG. 7 shows a functional configuration of a first communication environment prediction unit 200 which generates communication information indicating the communication environment in an area to which the vehicle loaded with the navigation device 1 moves, based on the GPS signals. The first communication environment prediction unit 200 is configured by the constitutional elements of the navigation device 1 shown in FIG. 3. As shown, the first communication environment prediction unit 200 includes a signal receiving unit 201, a position information detecting unit 202, a map information storage unit 203, a navigation processing unit 204, a traveling history generating unit 205, a storage unit 206, a communication control unit 207, a communication unit 208 and an AV reproduction unit 209.

The signal receiving unit 201 receives the GPS signals 19 from the GPS satellites by the GPS antenna 180. The signal receiving unit 201 functions as a signal receiving means of the present invention.

The position information detecting unit 202 detects a receiving time of the GPS signals, a receiving satellite number indicating the number of the satellites from which the GPS signals are received and position information indicating the position of the vehicle loaded with the navigation device 1. While the position information is the information of the latitude, longitude and altitude indicating the position of the vehicle at the time of receiving the GPS signals, it is assumed in this embodiment that the position information is the information of the latitude and the longitude, for the sake of convenience. The detected position information is stored in the storage unit 206. The position information detecting unit 202 functions as the position information detecting means of the present invention.

The map information storage unit 203 stores the map information, and configured by the data storage unit 36. The map information storage unit 203 functions as the map information storage means of the present invention.

The navigation processing unit 204 includes a traveling route calculating unit and a matching unit.

The traveling route calculating unit calculates a traveling route of the vehicle based on the position information detected by the position detecting unit 202 and the map information stored in the map information storage unit 203. The calculated traveling route is stored in the storage unit 206. Specifically, the traveling route calculating unit refers to the route calculation purpose information including the link data based on the position information, and performs the matching to calculate the traveling route of the vehicle. By this, the traveling route can be specified even if there is a point where the GPS signals cannot be received by the obstacles. Further, the navigation processing unit 204 may realize the stand-alone position measurement by the stand-alone position measurement device 10 at the point where the GPS signals cannot be received, and may correct the traveling route calculated based on the stand-alone measurement. The traveling route calculated by the traveling route calculating unit is stored in the storage unit 206 and is displayed on the display 44 as the navigation image. The traveling route calculating unit functions as a traveling route calculating means of the present invention.

The matching unit matches an interrupted section set by the interrupted section setting unit described later with the traveling route calculated by the traveling route calculating unit to generate communication interrupted route information indicating successive points at which the communication is presumed to be interrupted. The communication interrupted route information is stored in the storage unit 206. The matching unit functions as a communication interrupted route information generating means.

The traveling history generating unit 205 includes a position measurement information generating unit, an interrupted point setting unit, an interrupted section setting unit, and a communication information generating unit.

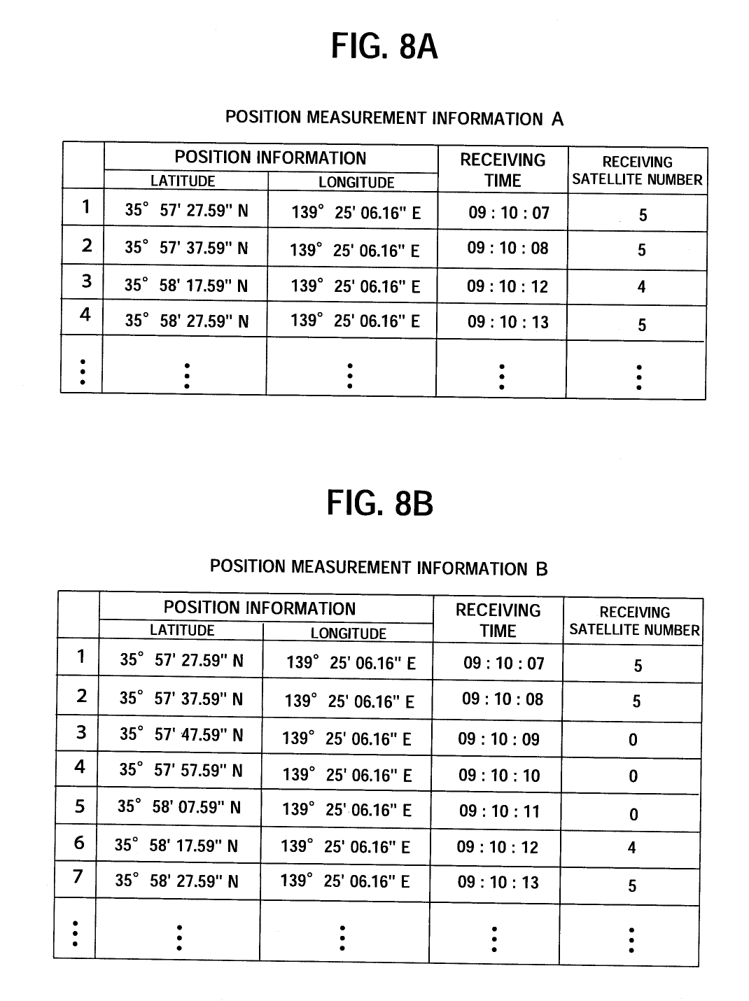

The position measurement information generating unit generates the position measurement information A, as shown in FIG. 8A, based on the position information, the receiving time and the received satellite number detected by the position information detecting unit 202. As shown, as the position measurement information, the position information including the latitude and the longitude, the receiving time and the receiving satellite number are corresponded with each other. The position measurement by the GPS satellites is performed with a constant interval. In this embodiment, the GPS satellites measures the position with the interval of 1 second, and the signal receiving unit 201 receives the GPS signal 19 with the interval of 1 second. In the example shown, the position information and the receiving satellite number corresponding to 3 seconds, i.e., the receiving time “09:10:09”, “09:10:10” and “09:10:11” are not stored. This is because the signal receiving unit 201 could not receive the GPS signals due to the obstacles. Namely, the receiving satellite number for the 3 seconds “09:10:09”, “09:10:10” and “09:10:11” is zero. Therefore, the position measurement information generating unit complements the position information of the points where the receiving satellite number is zero to generate the position measurement information as shown in FIG. 8B. The position information of the points where the receiving satellite number is zero is complemented by the automatic sampling based on the traveling route calculated by the traveling route calculating unit. The generated position measurement information is stored in the storage unit 206. The position measurement information generating unit functions as a position measurement information generating means.

The interrupted point setting unit sets the point, specified by the position information whose receiving satellite number is zero, to the communication interrupted point based on the position measurement information generated by the position measurement information generating unit. The communication interrupted point thus set is stored in the storage unit 206. The interrupted point setting unit is an interrupted point setting means of the present invention.

The interrupted section setting unit sets the successive communication interrupted points set by the interrupted point setting unit to the communication interrupted section. The communication interrupted section thus set is stored in the storage unit 206. The interrupted section setting unit is an interrupted section setting means of the present invention.

The communication information generating unit generates communication information indicating the communication environment in the area to which the vehicle moves, based on the position measurement information stored in the storage unit 206. At that time, the communication information generating unit may refer to the communication interrupted route information stored in the storage unit 206. The communication information generated is stored in the storage unit 206. The communication information generating unit functions as a communication information generating means of the present invention.

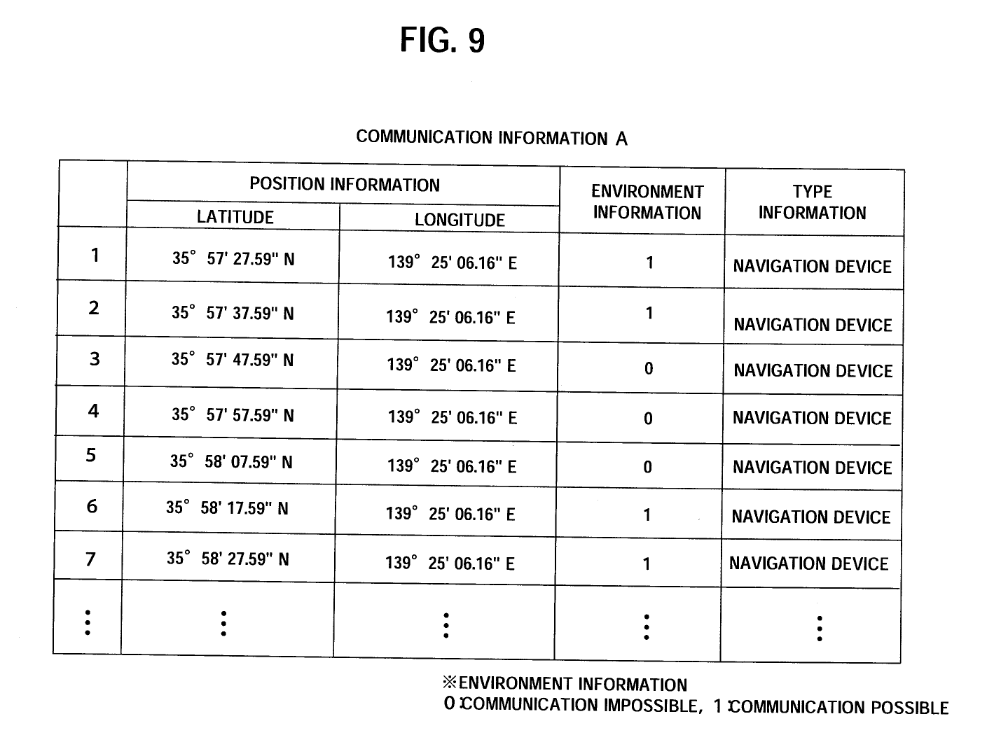

The examples of the communication information is shown in FIGS. 9 to 11. FIG. 9 shows the example of the communication information A. The communication information A indicates the communication environment in the area to which the vehicle moves, and the position information, the environment information and the type information are corresponded with each other. The environment information in the communication information A is defined such that “0” indicates that the communication is impossible and “1” indicates that the communication is possible. Specifically, the communication information generating unit determines that the communication is possible if the receiving satellite number is equal to or larger than three, and determines that the communication is impossible if the receiving satellite number is smaller than three. Based on the position measurement information, the communication information generating unit generates the communication information A, whose the environment information corresponding to the point where the receiving satellite number is equal to or larger than three is “1” and whose environment information corresponding to the point where the receiving satellite number is smaller than three is “0”. The type information indicates the type of the terminal which receives the GPS signals 19, and it is the navigation device in this first embodiment. The type information is corresponded with the communication information because the accuracy of the position measurement information varies dependently upon the type of the terminal which receives the GPS signals.

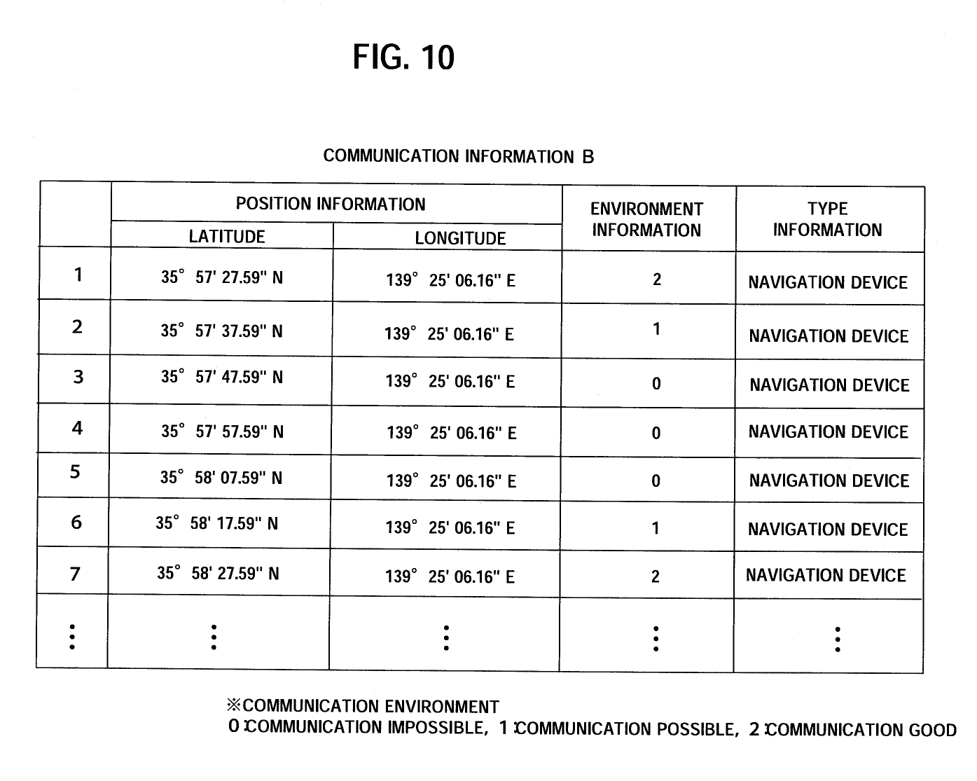

FIG. 10 is the example of the communication information B. The environment information in the communication information B is defined such that “0” indicates that the communication is impossible, “1” indicates that the communication is possible, and “2” indicates that the communication is good. Namely, the environment information is classified by the level. Specifically, the communication information generating unit determines that the communication is good if the receiving satellite number is equal to or larger than four, determines that the communication is possible if the receiving satellite number is equal to three, and determines that the communication is impossible if the receiving satellite number is smaller than three. Based on the position measurement information, the communication information generating unit generates the communication information B, whose environment information corresponding to the point where the receiving satellite number is equal to or larger than four is “2”, whose environment information corresponding to the point where the receiving satellite number is three is “1”, and whose environment information corresponding to the point where the receiving satellite number is smaller than three is “0”.

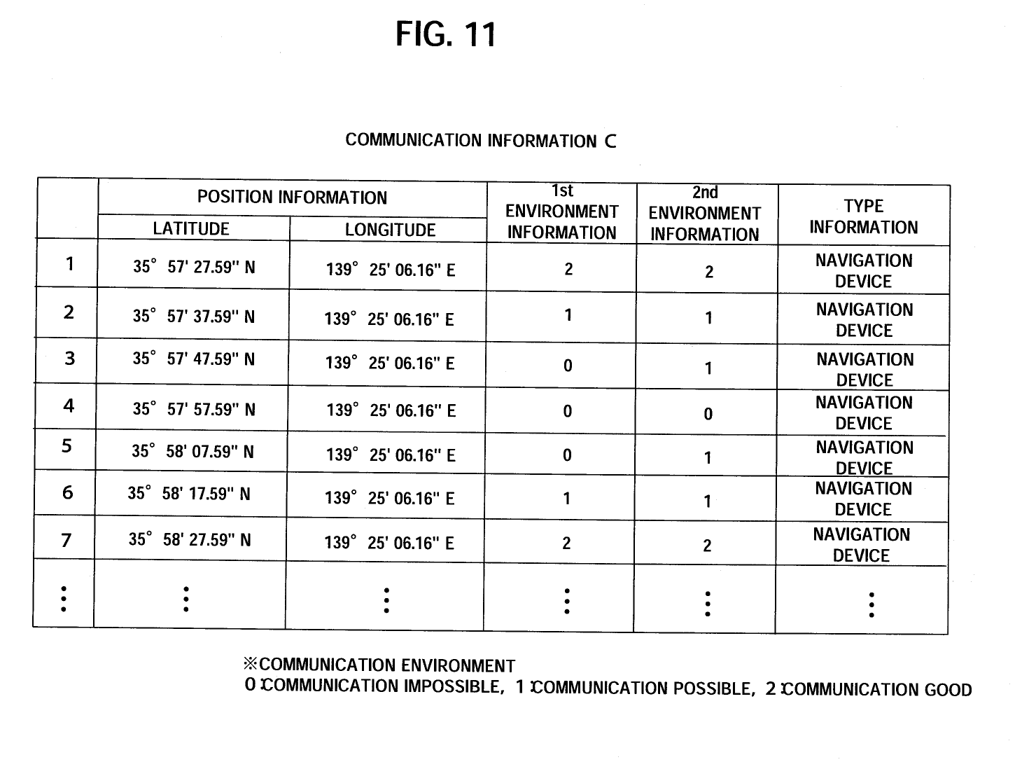

FIG. 11 is the example of the communication information C. In the communication information C, two environment information are prepared. Namely, the communication information C includes first environment information and second environment information. The definition of each of the environment information is different and can be arbitrarily set. In this first embodiment, while the environment information in the communication information is defined based on the receiving satellite number, the definitions of the receiving satellite number and the environment information are arbitrary. The present invention is not limited to this example, and the environment information may be defined based on not only the receiving satellite number but the communication interrupted route information.

As described above, the communication information is the data predicting the communication environment in a certain area and indicating the communication state of each area. It is possible to predict the communication state between the areas based on the communication information.

The storage unit 206 stores the position information, the traveling route, the position measurement information, the communication interrupted points, the communication interrupted sections and the communication information, and is configured by the data storage unit 36 of the navigation device 1 shown in FIG. 3.

The communication control unit 207 uploads the communication information stored in the storage unit 206 to the communication environment prediction server 3 from the communication unit 208 on the real-time basis. In addition, the communication control unit 207 uploads the position information, the traveling route, the position measurement information, the latitude and longitude obtained during the traveling to the communication environment prediction server 3 from the communication unit 208, as necessary. Further, the communication control unit 207 downloads and uses the updated, newest communication environment prediction map from the communication environment prediction server 3. Specifically, the communication environment control unit 207 obtains the newest communication environment prediction map by downloading from the communication environment prediction server 3 based on the latitude and longitude of the point to which the vehicle reaches in future, and uses it for the stable communication control. The communication control unit 207 and the communication unit 208 are configured by the communication device 38 of the navigation device 1 shown in FIG. 3.

The AV reproduction unit 209 displays the image on the display 44 and outputs the audio from the speaker 53 by reproducing the contents data. If the communication control unit 207 refers to the communication environment prediction map obtained from the communication environment prediction server 3, the AV reproduction unit 209 enables to enjoy the video contents in the moving vehicle. The AV reproduction unit 209 is configured by the display unit 40 and the sound unit 50 of the navigation device 1 shown in FIG. 3.

### (ii) Server Unit

FIG. 7 shows a functional configuration of a server unit 150 for predicting communication environment of the area to which the vehicle loaded with the navigation device 1 moves. The server unit 150 is substantially configured by the communication environment prediction server 3 on the network 2. The server unit 150 includes a map information storage unit 151, a communication unit 152, a communication information generating unit 153 and a storage unit 154.

The map information storage unit 151 stores the map information. Since the map information is the same as the information stored in the navigation device 1, the description thereof will be omitted for convenience.

The communication unit 152 transmits and receives the information with the navigation device 1 and the terminal device 5 via the network 2. Specifically, the communication unit 152 obtains the position measurement information and the type information and/or the communication information. The position measurement information and the communication information obtained are stored in the storage unit 154. In addition, the communication unit 152 provides the communication environment prediction map generated based on the plural communication information to the navigation device 1 and/or the terminal device 5, as necessary. The communication environment prediction map is stored in the storage unit 154. The communication unit 152 functions as a position measurement information obtaining means and a communication information obtaining means of the present invention.

The communication information generating unit 153 generates the communication information indicating the communication environment in the area to which the vehicle loaded with the navigation device 1 moves, based on the position measurement information obtained by the communication unit 152 from the navigation device 1. The generated communication information is stored in the storage unit 154. Further, the communication information generating unit 153 generates the communication environment prediction map predicting the communication environment at a certain area, based on the plural communication information stored in the storage unit 154, and stores it in the storage unit 154. The communication information generating unit 153 functions as a communication information generating means and a prediction information generating means of the present invention.

When obtaining the communication information from the navigation device 1, the communication information generating unit 153 does not have to generate the communication information. Namely, whether the communication information is generated on the communication environment prediction terminal side or the communication environment prediction server 3 side may be arbitrarily set. Further, whether the communication information is generated at the timing that the position measurement information is uploaded or at the timing that the position measurement information is read, may be arbitrarily set. The communication environment prediction terminal is the navigation device and/or a PND (Portable Navigation Device) described later, including the communication environment prediction unit.

The storage unit 154 stores the position measurement information and the communication information obtained from the navigation device 1, and the communication information and/or the communication environment prediction map generated by the communication information generating unit 153.

### (iii) Accuracy Improving Method

One method of improving the accuracy of predicting the communication environment is to merge plural communication information.

The communication environment prediction server 3 generates the communication environment prediction map predicting the communication environment in a certain area, based on the communication information obtained from the plural navigation devices 1. Since the vehicle moving speed and the position measurement timing is different between the plural navigation devices, the accuracy of the communication environment prediction map may be improved by merging the plural communication information obtained from the plural navigation devices 1.

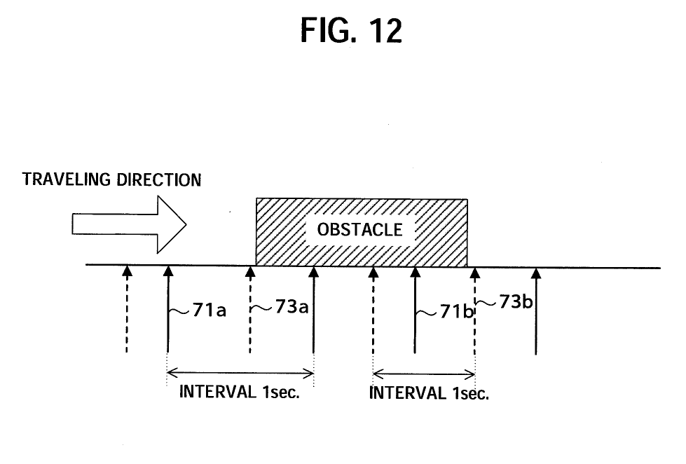

FIG. 12 is a diagram showing the position measurement timings of two navigation devices 1 by the solid line arrows and the broken line arrows. As shown, if both of the position measurement timings of two navigation devices 1 have the interval of 1 second, the position measurement timings are different between the solid line arrows and the broken line arrows due to the moving speed of the vehicle. In the example shown, the end of the obstacle has a large gap from the position measurement timings 71a and 71b of the solid line arrows but has a small gap from the position measurement timings 73a and 73b of the broken line arrows. Therefore, the communication environment prediction server 3 generates the communication environment prediction map having a large gap based on only the position measurement timings of the solid line arrows, but can generate the communication environment prediction map having a small gap by merging the communication information of the position measurement timings of the solid line arrows and the communication information of the position measurement timings of the broken line arrows. Thus, the accuracy of the communication environment can be improved by using as many communication information as possible.

Another method of improving the accuracy of the prediction of the communication environment is to add the type information indicating the type of the terminal which receives the GPS signals.

The navigation device 1 does not specify the vehicle position only by the position information detected based on the GPS signals, but specifies the vehicle position with high accuracy by the map matching that checks the vehicle position with the traveling route and/or by using the stand-alone position measurement result. As the method of specifying the vehicle position by a mobile phone, there are two methods, i.e., a simple position measurement method and a position measurement method using the GPS signals. Since the accuracy of specifying the vehicle position is different dependently upon the terminal receiving the GPS signals, the accuracy of the generated communication environment prediction map can be improved by merging the communication information in consideration of the type information. Namely, the accuracy of predicting the communication environment can be improved by varying the weights of the terminals by their type according to the type information.

### (iv) 1st Communication Information Generating Process

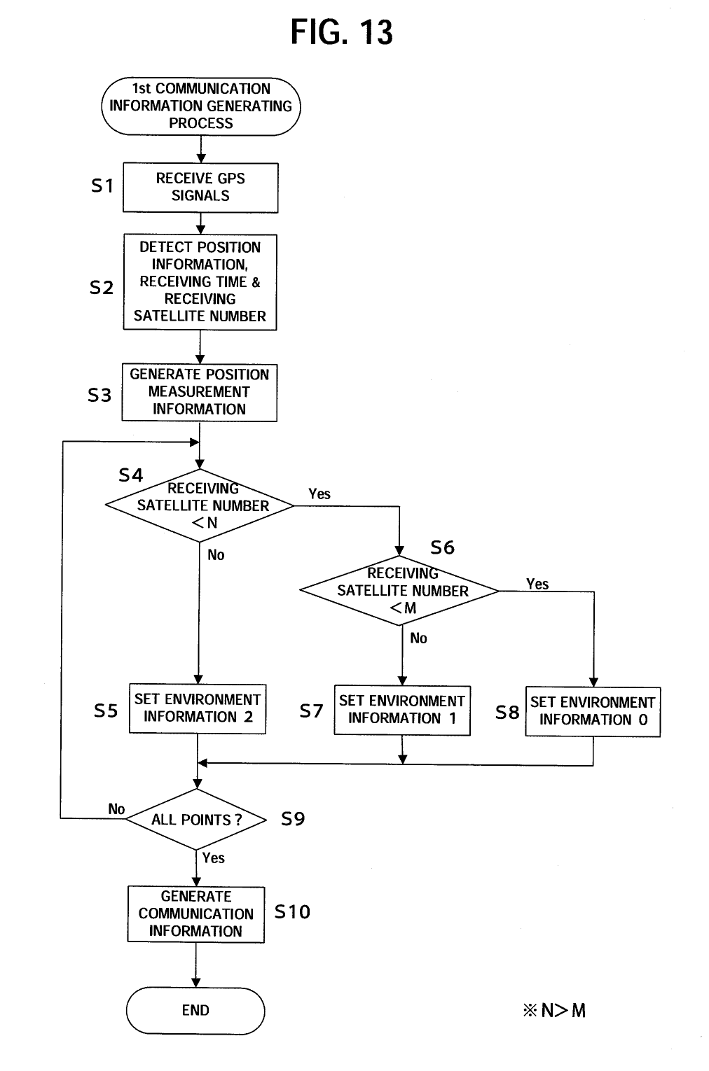

Next, a first communication information generating process according to the first embodiment will be described with reference to FIG. 13. FIG. 13 is a flowchart of the first communication information generating process according to the first embodiment. The first communication information generating process is the process that the navigation device 1 having the first communication information environment prediction unit 200 generates the communication information indicating the communication environment in the area to which the vehicle moves, based on the GPS signals.

The signal receiving unit 201 of the first communication environment prediction unit 200 receives the GPS signals 19 from the GPS satellites (step S1). Then, the position information detecting unit 202 detects the vehicle position information, the receiving time and the receiving satellite number based on the GPS signals received by the signal receiving unit 201 (step S2). The position measurement information generating unit generates the position measurement information based on the position information, the receiving time and the receiving satellite number detected by the position information detecting unit 202 (step S3). Then, the communication information generating unit determines whether or not the receiving satellite number at the point indicated by the position information is smaller than N, based on the position measurement information (step S4). If the receiving satellite number is not smaller than N (step S4; No), i.e., if the receiving satellite number is larger than N, the communication information generating unit sets the environment information of the point indicated by the position information to “2; Good” (step S5).

If the receiving satellite number is smaller than N (step S4; Yes), the communication information generating unit determines whether or not the receiving satellite number of the point indicated by the position information is smaller than M (step S6). It is noted that “M” is the number smaller than “N”. If the receiving satellite number is not smaller than M (step S6; No), i.e., if the receiving satellite number is not smaller than M and smaller than N, the communication information generating unit sets the environment information of the point indicated by the position information to “1; Possible” (step S7). On the other hand, if the receiving satellite number is smaller than M (step S6; Yes), the communication information generating unit sets the environment information of the point indicated by the position information to “0; Impossible” (step S8).

Then, the communication information generating unit determines whether or not the environment information is set to the points indicated by all the position information included in the position measurement information (step S9). If it is not determined to be set (step S9; No), the communication information generating unit repeatedly executes the process of steps S4 to S9. On the other hand, if it is determined to be set (step S9; Yes), the communication information generating unit generates the communication information in which the position information, the environment information and the type information indicating the type of the terminal that received the GPS signals are corresponded with each other (step S10). Thus, the first communication information generating process ends.

By executing the first communication information generating process as described above, the navigation device 1 generates the communication information indicating the communication environment in the area to which the vehicle carrying itself moves, based on the GPS signals 19, by supposing that the communication situation is bad due to the obstacles at the point where the GPS signals 19 cannot be received. The navigation device updates the generated communication information to the communication environment prediction server 3 on the network 2. The communication environment prediction server 3 can predict the communication environment in a certain area with high accuracy based on the communication information obtained from the plural navigation devices 1.

### (v) 2nd Communication Information Generating Process

While the navigation device 1 having the first communication environment prediction unit 200 generates the communication information, the present invention is not limited to this example. The communication environment prediction server 3 may obtain the type information and the position measurement information from the navigation device 1 to generate the communication information based on the type information and the position measurement information.

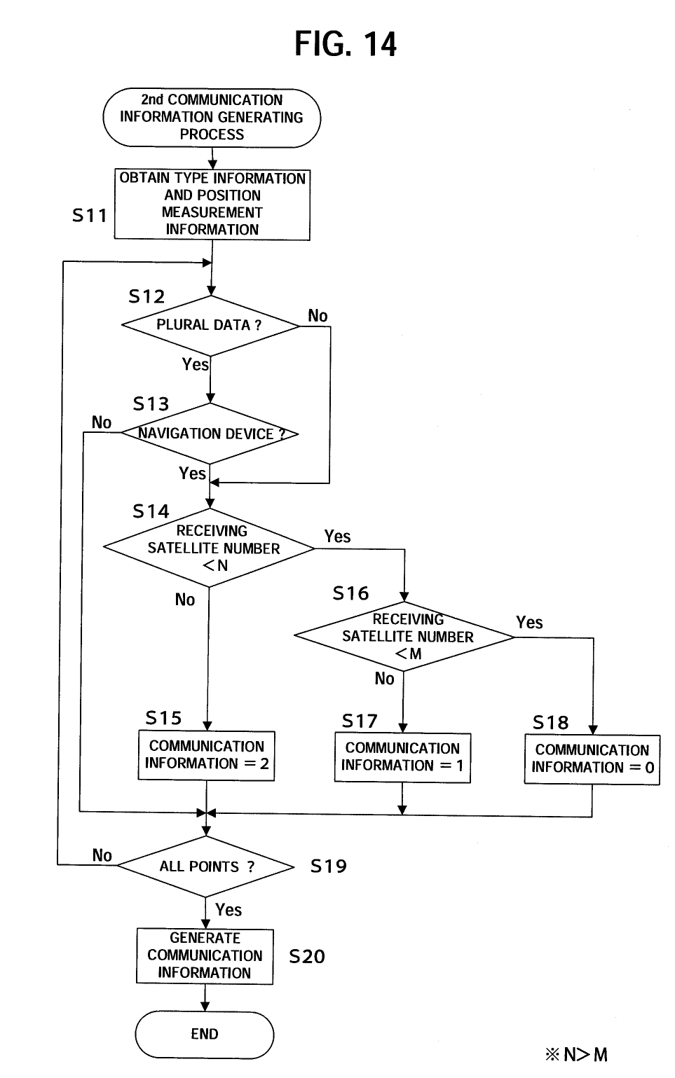

The second communication information generating process will be described with reference to FIG. 14. FIG. 14 is a flowchart of the second communication generating process.

The communication unit 152 of the server unit 150 obtains the type information and the position measurement information from the navigation device 1 via the network 2 (step S11). Subsequently, the communication information generating unit 153 determines whether or not plural pairs of the type information and the position measurement information thus obtained exist (step S12). If the plural pairs do not exist (step S12; No), i.e., the pair of the type information and the position measurement information thus obtained is one, the communication information generating unit 153 goes to the process of step S14. On the other hand, if the plural pairs of the type information and the position measurement information obtained exist (step S12; Yes), the communication information generating unit 153 determines whether or not the position measurement information is generated by the navigation device 1, based on the type information (step S13).

If there are plural pairs of the type information and the position measurement information obtained in step S12, the communication information generating unit 153 determines whether or not the receiving satellite number at the point indicated by the position information is smaller than N, based on only the position measurement information by the navigation device 1 (step S14). On the other hand, if there is one pair of the type information and the position measurement information obtained in step S12, the communication information generating unit 153 determines whether or not the receiving satellite number at the point indicated by the position information is smaller than N, based on the position measurement information (step S14).

If the receiving satellite number is not smaller than N (step S14; No), i.e., the receiving satellite number is equal to or larger than N, the communication information generating unit 153 sets the environment information of the point indicated by the position information to “2; Good” (step S15).

If the receiving satellite number is smaller than N (step S14; Yes), the communication information generating unit 153 determines whether or not the receiving satellite number at the point indicated by the position information is smaller than M (step S16). It is noted that “M” is a number smaller than “N”. If the receiving satellite number is not smaller than M (step S16; No), i.e., the receiving satellite number is not smaller than M and smaller than N, the communication information generating unit 153 sets the environment information of the point indicated by the position information to “1; Possible” (step S17). On the other hand, if the receiving satellite number is smaller than M (step S16; Yes), the communication information generating unit 153 sets the environment information of the point indicated by the position information to “0; Impossible” (step S18).

Then, the communication information generating unit 153 determines whether or not environment information is set to the points indicated by all the position information included in the position measurement information (step S19). If communication information generating unit 153 determines that it is not set (step S19; No), the communication information generating unit 153 repeatedly executes the process of steps S12 to S19. On the other hand, if the communication information generating unit 153 determines that it is set (step S19; Yes), the communication information generating unit 153 generates the communication information in which the position information, the environment information and the type information indicating the type of the terminal that received the GPS signals are corresponded with each other (step S20). Thus, the second communication information generating process ends.

By executing the second communication information generating process as described above, the communication environment prediction server 3 can generate the communication information indicating the communication environment in the area to which the vehicle loaded with the navigation device 1 moves, based on the type information and the position measurement information obtained from the navigation device 1. Further, the communication environment prediction server 3 can predict the communication environment at a certain area with high accuracy by the plural communication information generated.

In the first embodiment, the position information of the point where the GPS signals cannot be received is complemented based on the traveling route calculated by the traveling route calculating unit, and the position measurement information as shown in FIG. 8B is generated. However, the present invention is not limited to this. Since the navigation device 1 realizes the stand-alone position measurement, at the place where the GPS signals 19 cannot be received, based on the measurement result by the stand-alone position measurement device 10, the position information at the point where the GPS signals cannot be received may be complemented only based on the stand-alone position measurement result. Namely, the position measurement information and the communication information as shown in FIG. 8B may be generated without the matching with the traveling route.

Further, in the first embodiment, the communication environment prediction system 70 shown in FIG. 2 is supposed, and the navigation device 1 and the communication environment prediction server 3 can directly communication with each other via the network 2. However, the present invention is not limited to this, and the communication environment prediction system 80 shown in FIG. 1 is also supposed. In this case, the communication information stored in the storage unit 206 is uploaded to the communication environment prediction server 3 from the terminal device 5 capable of connecting with the network 2. In the case that the storage unit 206 is removable like a removable HDD, the storage unit 206 itself is removed and connected with the terminal device 5 as shown in FIG. 1. In the case that the storage unit 206 is not removable, the communication information may be separately copied to a recording medium.

### 2nd Embodiment

In the first embodiment, the navigation device 1 constituting the first communication environment prediction unit 200 has the storage unit. The navigation device constituting the second communication environment prediction unit 300 described in the second embodiment does not have the storage unit which stores the generated communication information. Therefore, the navigation device of the second embodiment does not need the data storage unit 36 shown in FIG. 3. The hardware configuration of the navigation device in the second embodiment is the same as the first embodiment except that the data storage unit 36 is not needed, and hence the description thereof will be omitted for convenience.

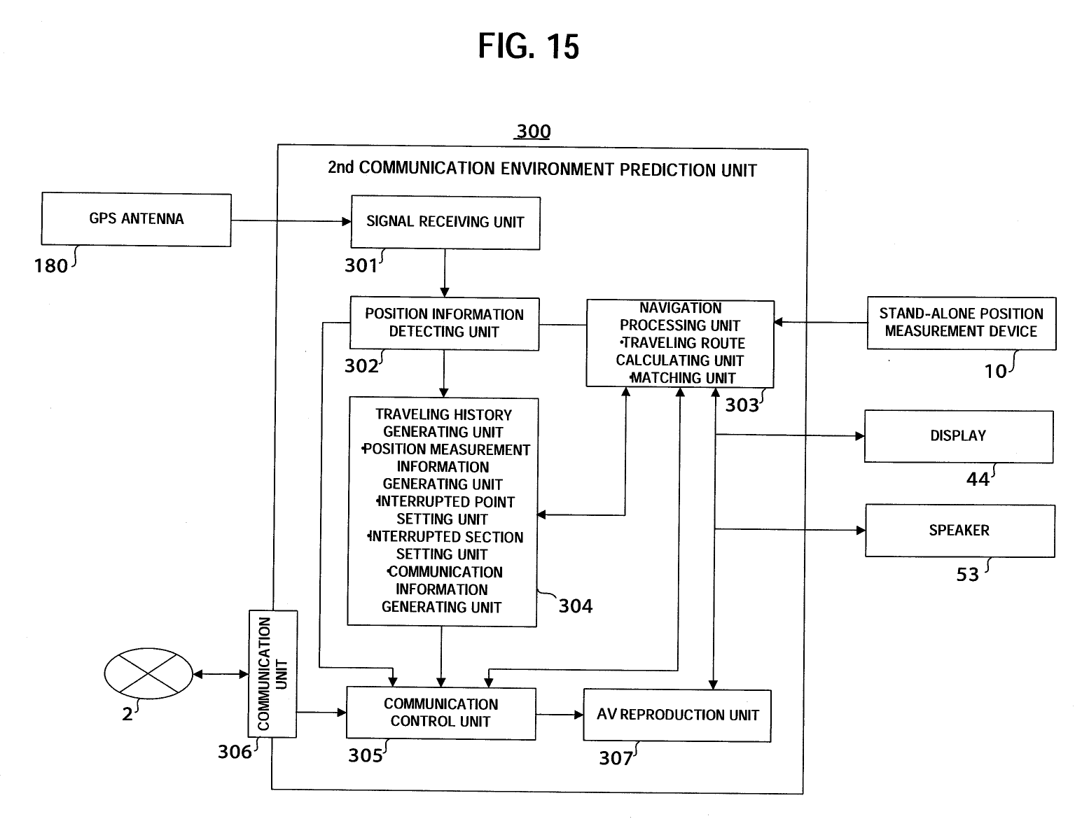

FIG. 15 shows the functional configuration of the second communication environment prediction unit 300 which generates the communication information indicating the communication environment in the area to which the vehicle loaded with the navigation device moves, based on the GPS signals 19. The second communication environment prediction unit 300 substantially has the communication function with the network 2, and is configured by the constitutional elements of the navigation device which does not have the map information storage unit and the storage unit. The second communication environment prediction unit 300 includes, as shown, a signal receiving unit 301, a position information detecting unit 302, a navigation processing unit 303, a traveling history generating unit 304, a communication control unit 305, a communication unit 306 and an AV reproduction unit 307.

The signal receiving unit 301 receives the GPS signals 19 from the GPS satellites by the GPS antenna 180.

The position information detecting unit 302 detects the receiving time of the GPS signals, the receiving satellite number which is the number of the GPS satellites from which the GPS signals are received, and the position information indicating the position of the vehicle loaded with the navigation device, based on the GPS signals 19 received by the signal receiving unit 301. While the position information is the information of the latitude, longitude and the altitude indicating the vehicle position at the time of receiving the GPS signals, it is assumed to be the information of the latitude and the longitude in the second embodiment, for convenience. The position information detected is transmitted to the communication environment prediction server 3 on the network by the communication control unit 305 and the communication unit 306, as necessary, and is stored.

The navigation processing unit 303 includes a traveling route calculating unit and a matching unit.

The traveling route calculating unit calculates the traveling route of the vehicle based on the position information detected by the position information detecting unit 302 and the map information obtained from the communication environment prediction server 3 by the communication control unit 305 and the communication unit 306 via the network 2. The calculated traveling route is transmitted to the communication environment prediction server 3 on the network by the communication control unit 305 and the communication unit 306, and is stored. The calculated traveling route is displayed on the display 44 as the navigation screen.

The map information obtained from the communication environment prediction server 3 is the same as that stored in the storage unit 206 in the first embodiment, and hence the description thereof will be omitted for convenience. The calculation, the correction and the display of the traveling route is also the same as those of the first embodiment, and hence the description thereof will be omitted for convenience. The traveling route calculating unit obtains the traveling route calculation result executed by the communication environment prediction server 3, as necessary, from the communication environment prediction server 3 by the communication control unit 305 and the communication unit 306. Namely, the calculation of the traveling route may be executed on the side of the communication environment prediction server 3.

The matching unit matches an interrupted section set by the interrupted section setting unit with the traveling route calculated and/or obtained by the traveling route calculating unit to generate communication interrupted route information indicating successive points at which the communication is interrupted.

The traveling history generating unit 304 includes a position measurement information generating unit, an interrupted point setting unit, an interrupted section setting unit and a communication information generating unit.

The position measurement information generating unit generates the position measurement information shown in FIG. 8B, based on the position information, the receiving time and the receiving satellite number detected by the position information detecting unit 302. The position measurement information generated is transmitted to the communication environment prediction server 3 on the network by the communication control unit 305 and the communication unit 306, and is stored. Since the generation of the position measurement information is the same as that in the first embodiment, the description thereof will be omitted for convenience.

The interrupted point setting unit sets the point, specified by the position information whose receiving satellite number is zero, to the communication interrupted point based on the position measurement information generated by the position measurement information generating unit. The communication interrupted point thus set is transmitted to the communication environment prediction server 3 on the network by the communication control unit 305 and the communication unit 306, and is stored.

The interrupted section setting unit sets the successive communication interrupted points set by the interrupted point setting unit to the communication interrupted section. The communication interrupted section is transmitted to the communication environment prediction server 3 on the network by the communication control unit 305 and the communication unit 306, and is stored.

The communication information generating unit generates the communication information indicating the communication environment in the area to which the vehicle moves, based on the position measurement information generated by the position measurement information generating unit. At this time, the communication information generating unit may refer to the communication interrupted route information generated by the matching unit. The generated communication information is transmitted to the communication environment prediction server 3 on the network by the communication control unit 305 and the communication unit 306, and is stored. Since the detail of the communication information is the same as that of the first embodiment, the description will be omitted for convenience.

The communication control unit 305 uploads the traveling route calculated by the traveling route calculating unit, the position measurement information generated by the position measurement information generating unit, the interrupted point set by the interrupted point setting unit, the interrupted section set by the interrupted section setting unit, the communication information generated by the communication information generating unit, and the latitude and longitude obtained from the traveling direction of the vehicle, to the communication environment prediction server 3 from the communication unit 306 on the real-time basis. Further, the communication control unit 305 downloads and uses the map information, the traveling route calculation result and the newest communication environment prediction map from the communication environment prediction server 3, as necessary. Specifically, the communication control unit 305 obtains the newest communication environment prediction map from the communication environment prediction server 3 by downloading as necessary, and uses it for the stable communication control. The communication control unit 305 and the communication unit 306 are configured by the communication device 38 of the navigation device 1 shown in FIG. 3.

The AV reproduction unit 307 reproduces the contents data to display the image on the display 44 and to output the sound from the speaker 53. The AV reproduction unit is configured by the display unit 40 and the audio reproduction unit 50 of the navigation device 1 shown in FIG. 3.

Since the server unit in the second embodiment is basically the same as that in the first embodiment, the description thereof will be omitted for convenience. When the navigation device requests the traveling route calculation result executed by the communication environment prediction server 3 as shown in the second embodiment, the server unit has the navigation processing unit and calculates the traveling route of the vehicle based on the map information stored in the map information storage unit 151 and the vehicle position information obtained from the navigation device by the communication unit 152. The traveling route calculation result thus calculated is provided to the navigation device 1 by the communication unit 152.

Since the accuracy improving method, the first communication information generating process and the second communication information generating process are basically the same as those of the first embodiment, the description thereof will be omitted for convenience.

By eliminating the storage unit from the navigation device in this way, the navigation device can be light.

### 3rd Embodiment

While the navigation device constituting the first communication environment prediction unit 200 is applied to the above first embodiment, the present invention is not limited to this, and a PND constituting a third communication environment prediction 400 may be applied. The PND is a simple type portable navigation device. Most of the PND achieves the navigation function by using only the GPS signals 19, and therefore the PND does not have the stand-alone position measurement device 10 of the navigation device 1 shown in FIG. 3. In addition, the PND in the third embodiment does not have the communication function with the network 2. Since the hardware configuration of the PND in the third embodiment is obtained by simplifying the hardware configuration of the navigation device 1 shown in FIG. 3, the description thereof will be omitted for convenience.

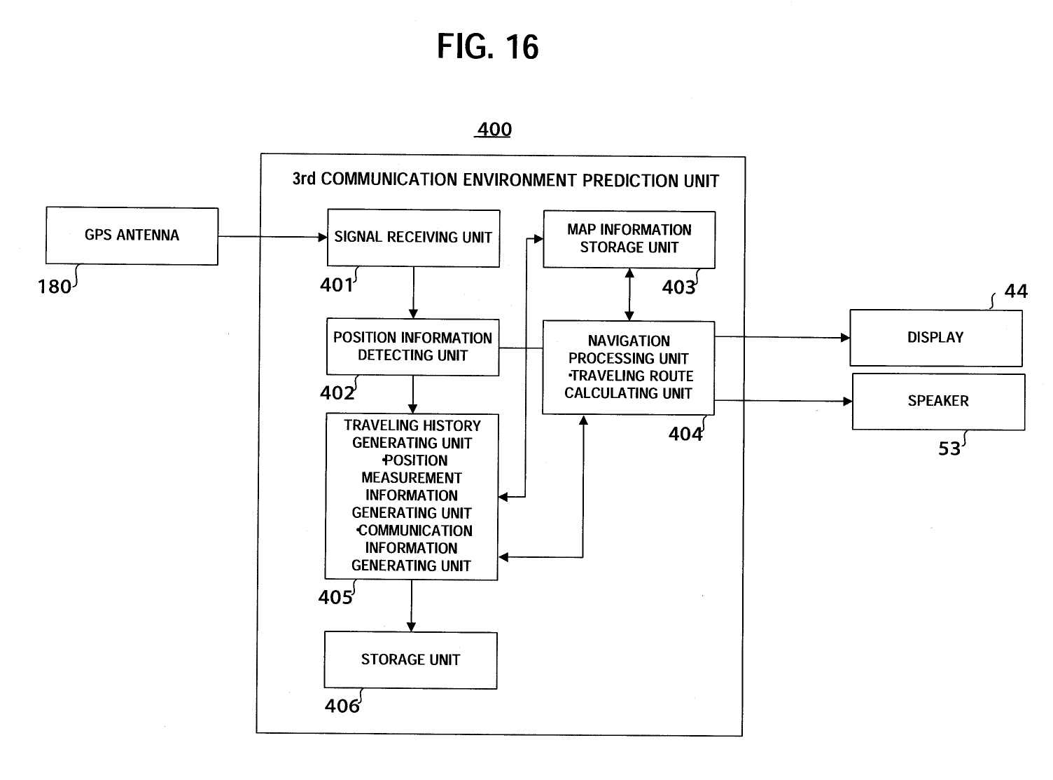

FIG. 16 shows the functional configuration of the third communication environment prediction unit 400 which generates the communication information indicating the communication environment, in the area to which the vehicle loaded with the PND without the communication function moves, based on the GPS signals 19. The third communication environment prediction unit 400 is substantially configured by the constitutional elements of the PND having no communication function to the network 2. As shown, the third communication environment prediction unit 400 includes a signal receiving unit 401, a position information detecting unit 402, a map information storage unit 403, a navigation processing unit 404, a traveling history generating unit 405 and a storage unit 406.

The signal receiving unit 401 receives the GPS signals 19 from the GPS satellites by the GPS antenna 180.

The position information detecting unit 402 detects the receiving time of the GPS signals 19, the receiving satellite number that is the number of the GPS satellites from which the GPS signals are received, and the position information indicating the position of the vehicle loaded with the PND, based on the GPS signals 19 received by the signal receiving unit 401. While the position information is the information of the latitude, the longitude and the altitude indicating the position of the vehicle at the time of receiving the GPS signals, it is assumed to be the latitude and the longitude information in this embodiment, for convenience. The detected position information is stored in the storage unit 406.

The map information storage unit 403 stores the map information.

The navigation processing unit 404 includes a traveling route calculating unit. The traveling route calculating unit calculates the traveling route of the vehicle based on the position information detected by the position detecting unit 402 and the map information stored in the map information storage unit 403. The calculated traveling route is stored in the storage unit 406. Further, the calculated traveling route is shown on the display 44 as the navigation image.

The traveling history generating unit 405 includes a position measurement information generating unit and a communication information generating unit.

The position measurement information generating unit generates the position measurement information shown in FIG. 8B, based on the position information, the receiving time and the receiving satellite number detected by the position information detecting unit 402. Unlike the navigation device 1 of the first embodiment, most of the PNDs achieve the navigation function by using only the GPS signals. Therefore, when the vehicle travels the point of the obstacle, e.g., inside of the tunnel and/or under the overhead bridge, it cannot accurately show the vehicle position. Therefore, the position measurement information is as shown in FIG. 8A in the third embodiment. The position measurement information thus generated is stored in the storage unit 406.

The communication information generating unit complements the position information of the point where the receiving satellite number is zero, by matching with the traveling route calculated by the traveling route calculating unit based on the position measurement information stored in the storage unit 406. Then, the communication information generating unit generates the communication information indicating the communication environment in the area to which the vehicle moves, based on the complemented position measurement information. The generated communication information is stored in the storage unit 406. In the third embodiment, the communication information stored in the storage unit 406 is uploaded to the communication environment prediction server 3 by the terminal device 5 capable of connecting with the network 2. It is noted that the type information corresponded to the communication information is PND.

The storage unit 406 stores the position information, the position measurement information and the communication information.

Since the server unit, the accuracy improving method, the first communication information generating process and the second communication information generating process are basically the same as those of the first embodiment, the description thereof will be omitted for convenience.

### 4th Embodiment

While the PND having no communication function with the network 2 is applied in the above third embodiment, the present invention is not limited to this, and the PND having the communication function with the network 2 may be applied. The communication function may be a data communication modem (portable). As other examples, there are a method of using the access point loaded on the vehicle and a method of indirectly connecting with the network 2 by the wireless communication with the mobile phone.

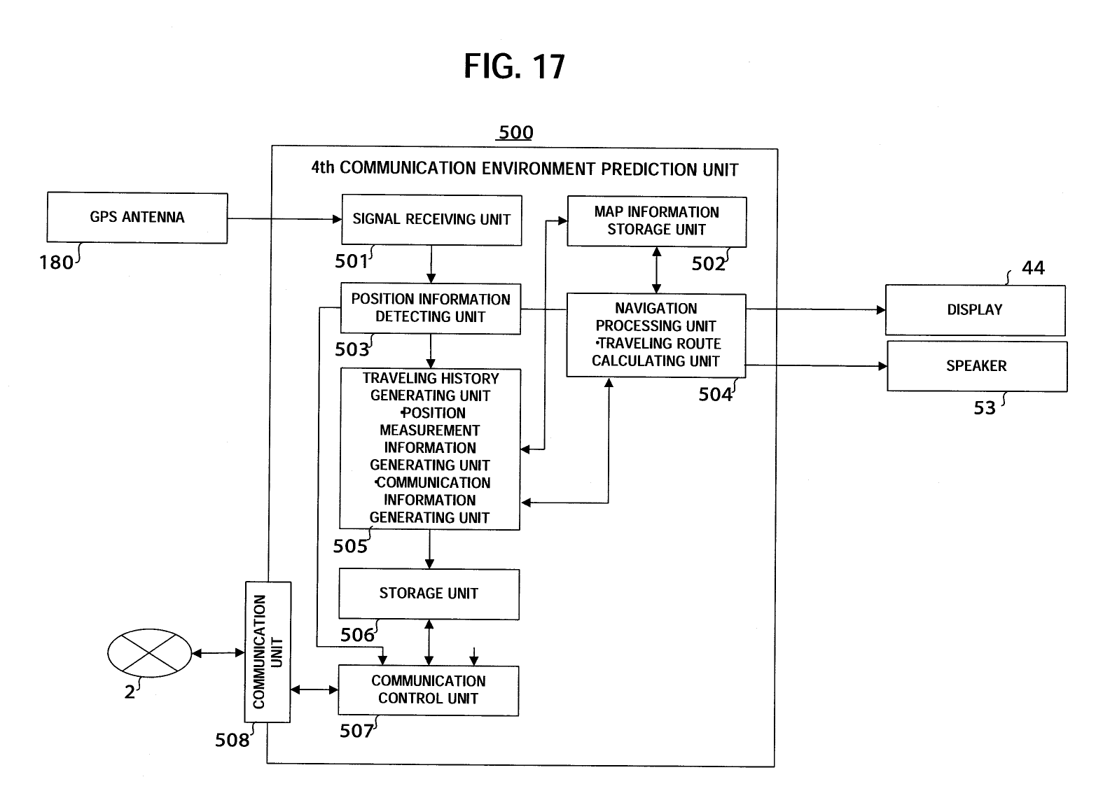

FIG. 17 shows the functional configuration of the fourth communication environment prediction unit 500 which generates the communication information, indicating the communication environment in the area to which the vehicle loaded with the PND having the communication function moves, based on the GPS signals 19. The fourth communication environment prediction unit 500 is substantially configured by the constitutional elements of the PND having the communication function. As shown, the fourth communication environment prediction unit 500 includes a signal receiving unit 501, a map information storage unit 502, a position information detecting unit 503, a navigation processing unit 504, a traveling history generating unit 505, a storage unit 506, a communication control unit 507 and a communication unit 508.

The signal receiving unit 501 receives the GPS signals 19 from the GPS satellites by the GPS antenna 180.

The map information storage unit 502 stores the map information.

The position information detecting unit 503 detects the receiving time of the GPS signals, the receiving satellite number that is the number of the GPS satellites from which the GPS signals are received, and the position information indicating the position of the vehicle loaded with the PND, based on the GPS signals 19 received by the signal receiving unit 501. While the position information is the information of the latitude, the longitude and the altitude indicating the position of the vehicle at the time of receiving the GPS signals, it is assumed to be the latitude and the longitude information in this embodiment, for convenience. The detected position information is stored in the storage unit 506.

The navigation processing unit 504 includes a traveling route calculating unit. The traveling route calculating unit calculates the traveling route of the vehicle based on the position information detected by the position detecting unit 503 and the map information stored in the map information storage unit 502. The calculated traveling route is stored in the storage unit 506. Further, the calculated traveling route is shown on the display 44 as the navigation image.

The traveling history generating unit 505 includes a position measurement information generating unit and a communication information generating unit.

The position measurement information generating unit generates the position measurement information shown in FIG. 8B, based on the position information, the receiving time and the receiving satellite number detected by the information detecting unit 503. Unlike the navigation device 1 of the first embodiment, most of the PNDs achieve the navigation function by using only the GPS signals. Therefore, when the vehicle travels the point of the obstacle, e.g., inside of the tunnel and/or under the overhead bridge, it cannot accurately show the vehicle position. Therefore, the position measurement information is as shown in FIG. 8A in the third embodiment uses. The position measurement information thus generated is stored in the storage unit 506.

The communication information generating unit complements the position information of the point where the receiving satellite number is zero, by matching with the traveling route calculated by the traveling route calculating unit based on the position measurement information stored in the storage unit 506. Then, the communication information generating unit generates the communication information indicating the communication environment in the area to which the vehicle moves, based on the complemented position measurement information. The generated communication information is stored in the storage unit 506.

The storage unit 506 stores the position information, the position measurement information and the communication information.

The communication control unit 507 uploads the communication information stored in the storage unit 506 to the communication environment prediction server 3 from the communication unit 508 on the real-time basis. Further, the communication control unit 507 uploads the position information and/or the position measurement information stored in the storage unit 506 to the communication environment prediction server 3 from the communication unit 508 on the real-time basis, as necessary. Still further, the communication control unit 507 downloads and uses the updated, newest communication environment prediction map from the communication environment prediction server 3. The information may be uploaded without using the real-time communication.

By this, the communication environment prediction server 3 or the communication environment prediction terminal can generate the communication information indicating the communication environment in the area to which the vehicle moves, by utilizing such a character that the GPS signals cannot be received in the place of the obstacles. Namely, the communication environment of a certain area can be predicted based on the plural communication information.

### Modified Example

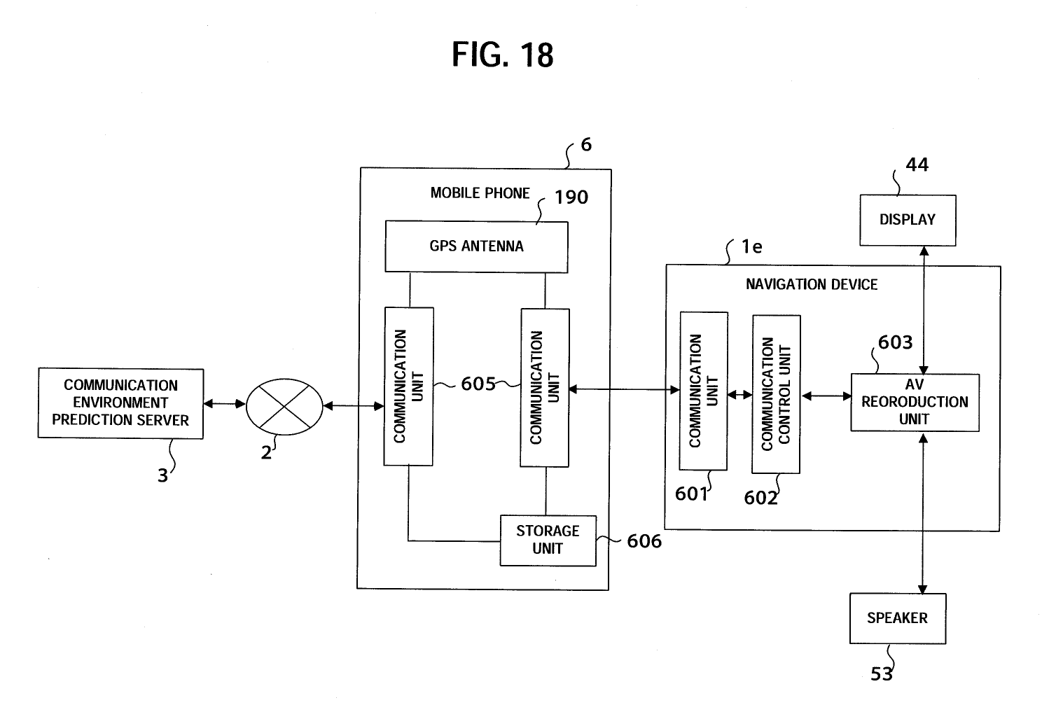

While the present invention is applied to the navigation using the navigation device or the PND in the above first to fourth embodiments, the present invention is not limited to this, and it may be applied to the navigation using the mobile phone. FIG. 18 shows a system configuration which achieves the navigation using the mobile phone.

In the system shown, the navigation device 1e cannot connect with the network 2, and hence cannot directly transmit and receive information to and from the communication environment prediction server 3 via the network 2. The navigation device 1e includes a communication unit 601, a communication control unit 602 and an AV reproduction unit 603. The communication control unit 602 transmits and receives information to and from the communication environment prediction server 3 by the communication unit 601 via the mobile phone 6. The AV reproduction unit 603 reproduces the contents data to show the image on the display 44 and output the sound from the speaker 53.

The mobile phone 6 includes a GPS antenna 190, a communication unit 605 and a storage unit 606. The communication unit 605 can perform the wireless communication with the navigation device 1e, and can connect with the network 2. The mobile phone 6 transmits and receives various information between the navigation device 1e and the communication environment prediction server 3. The storage unit 606 is a memory for storing various information.

By this system, it is possible to realize the communication-type navigation device, like the second embodiment, by the AV function loaded on the vehicle by utilizing the communication function of the mobile phone 6. In this case, the GPS signals 19 received by the mobile phone 6 can be transmitted to the communication environment prediction server 3 on the network 2 on the real-time basis. Further, the navigation device 1e can obtain the contents of map of the surrounding area from the communication environment prediction server 3 via the mobile phone 6. Still further, the communication environment prediction server 3 generates the communication information. At this time, the navigation device 1e may obtain and use the newest communication information from the communication environment prediction server 3 via the mobile phone 6.

### INDUSTRIAL APPLICABILITY

This invention can be used in various terminals as the method of predicting the communication environment in a certain area based on the GPS signals.

1. A communication environment prediction terminal loaded on a vehicle, comprising:
a signal receiving means which receives GPS signals from GPS satellites by using satellite communication;
a position information detecting means which detects position information indicating a position of the vehicle based on the GPS signals;
a position measurement information generating means which generates a position measurement information including the position information; and
a communication information generating means which generates communication information indicating communication environment in an area to which the vehicle moves, based on the position measurement information.

2. The communication environment prediction terminal according to claim 1, wherein the position measurement information includes a receiving time of the GPS signals and the position information of the vehicle based on the GPS signals, corresponded with each other.

3. The communication environment prediction terminal according to claim 1,
wherein the position measurement information includes a receiving satellite number which is a number of the GPS satellites from which the GPS signals are received, and the position information of the vehicle based on the GPS signals, corresponded with each other, and
wherein the communication information generating means generates the communication information indicating that the communication environment is good at a point specified by the position information whose receiving satellite number is large and the communication environment is bad at the point specified by the position information whose receiving satellite number is small, based on the position measurement information.

4. The communication environment prediction terminal according to claim 1, wherein the communication information is corresponded with type information relating to a type of the communication environment prediction terminal.

5. The communication environment prediction terminal according to claim 3, wherein the communication information generating means comprises:
an interrupted point setting means which sets a point, specified by the position information whose receiving satellite number is zero, to a communication interrupted point; and
an interrupted section setting means which sets successive communication interrupted points to a communication interrupted section, and
wherein the communication information generating means generates the communication information based on information relating to the communication interrupted point and the communication interrupted section.

6. The communication environment prediction terminal according to claim 5, further comprising:
a map information storage means which stores map information;
a traveling route calculating means which calculates a traveling route of the vehicle based on the position information and the map information; and
a communication interrupted route information generating means which specifies a communication interrupted route by comparing the traveling route with the communication interrupted section and which is related to the communication interrupted route,
wherein the communication information generating means generates the communication information based on the position measurement information and the communication interrupted route information.

7. A communication environment prediction method executed by a communication environment prediction terminal loaded on a vehicle, comprising:
a signal receiving process which receives GPS signals from GPS satellites by using satellite communication;
a position information detecting process which detects position information indicating a position of the vehicle based on the GPS signals;
a position measurement information generating process which generates a position measurement information including the position information; and
a communication information generating process which generates communication information indicating communication environment in an area to which the vehicle moves, based on the position measurement information.

8. A communication environment prediction program executed by a computer loaded on a vehicle, making the computer to function as:
a signal receiving means which receives GPS signals from GPS satellites by using satellite communication;
a position information detecting means which detects position information indicating a position of the vehicle based on the GPS signals;
a position measurement information generating means which generates a position measurement information including the position information; and
a communication information generating means which generates communication information indicating communication environment in an area to which the vehicle moves, based on the position measurement information.

9. A storage medium on which the communication environment prediction program according to claim 8 is stored.

10. A communication environment prediction server capable of communicating with communication environment prediction terminals loaded on plural vehicles, respectively, comprising:
a position measurement information obtaining means which obtains, from the communication environment prediction terminal, position measurement information including position information indicating a position of the vehicle detected based on GPS signals; and
a communication information generating means which generates communication information indicating communication environment in an area to which the vehicle moves, based on the position measurement information.

11. A communication environment prediction system comprising communication environment prediction terminals respectively loaded on plural vehicles, and a communication environment prediction server which performs process based on information obtained from the communication environment prediction terminals, the communication environment prediction terminals and the communication environment prediction server capable of communicating with each other,
wherein the communication environment prediction terminal comprises:
a signal receiving means which receives GPS signals from GPS satellites by using satellite communication;
a position information detecting means which detects position information indicating a position of the vehicle based on the GPS signals;
a position measurement information generating means which generates a position measurement information including the position information; and
a communication information generating means which generates communication information indicating communication environment in an area to which the vehicle moves, based on the position measurement information, and
wherein the communication environment prediction server comprises:
a communication information obtaining means which obtains the communication information from the plural communication environment prediction terminals; and
a prediction information generating means which generates prediction information predicting the communication environment in a predetermined area, based on the plural communication information obtained by the communication information obtaining means.

12. A data generating method comprising:
a signal receiving process which receives GPS signals from GPS satellites by using satellite communication;
a position information detecting process which detects position information of a specific area based on the GPS signals;
a position measurement information generating process which generates position measurement information including the position information; and
a data generating process which predicts the communication environment in the specific area and generates data indicating the communication environment for each area.

13. The data generating method according to claim 12, further comprising:
a predicting process which predicts the communication environment between areas from the data generated by the data generating process.

14. A communication environment prediction terminal loaded on a vehicle, comprising:
a signal receiving unit which receives GPS signals from GPS satellites by using satellite communication;
a position information detecting unit which detects position information indicating a position of the vehicle based on the GPS signals;
a position measurement information generating unit which generates a position measurement information including the position information;
a communication information generating unit which generates communication information indicating a communication environment in an area to which the vehicle moves, based on the position measurement information;
a map information storage unit which stores map information; and
a traveling route calculating unit which calculates a traveling route of the vehicle based on the position information and the map information,
wherein the position measurement information includes a receiving satellite number which is a number of the GPS satellites from which the GPS signals are received, and the position information of the vehicle based on the GPS signals, corresponded with each other,
wherein the communication information generating unit comprises:
an interrupted point setting unit which sets a point, specified by the position information whose receiving satellite number is zero, to a communication interrupted point;
an interrupted section setting unit which sets successive communication interrupted points to a communication interrupted section; and
a communication interrupted route information generating unit which specifies a communication interrupted route by comparing the traveling route with the communication interrupted section and generates communication interrupted route information related to the communication interrupted route, and
wherein the communication information generating unit generates the communication information based on the position measurement information and the communication interrupted route information.

15. The communication environment prediction terminal according to claim 14, wherein the position measurement information includes a receiving time of the GPS signals and the position information of the vehicle based on the GPS signals, corresponded with each other.

16. The communication environment prediction terminal according to claim 1, wherein the communication information generating unit generates the communication information indicating that the communication environment is good at a point specified by the position information whose receiving satellite number is large and the communication environment is bad at the point specified by the position information whose receiving satellite number is small, based on the position measurement information.

17. The communication environment prediction terminal according to claim 1, wherein the communication information is corresponded with type information relating to a type of the communication environment prediction terminal.

18. A communication environment prediction method executed by a communication environment prediction terminal loaded on a vehicle, comprising:
a signal receiving process which receives GPS signals from GPS satellites by using satellite communication;
a position information detecting process which detects position information indicating a position of the vehicle based on the GPS signals;
a position measurement information generating process which generates a position measurement information including the position information;
a communication information generating process which generates communication information indicating a communication environment in an area to which the vehicle moves, based on the position measurement information;
a map information storage process which stores map information; and
a traveling route calculating process which calculates a traveling route of the vehicle based on the position information and the map information,
wherein the position measurement information includes a receiving satellite number which is a number of the GPS satellites from which the GPS signals are received, and the position information of the vehicle based on the GPS signals, corresponded with each other,
wherein the communication information generating process comprises:
an interrupted point setting process which sets a point, specified by the position information whose receiving satellite number is zero, to a communication interrupted point;
an interrupted section setting process which sets successive communication interrupted points to a communication interrupted section; and
a communication interrupted route information generating process which specifies a communication interrupted route by comparing the traveling route with the communication interrupted section and generates communication interrupted route information related to the communication interrupted route, and
wherein the communication information generating process generates the communication information based on the position measurement information and the communication interrupted route information.

19. A communication environment prediction program executed by a computer included in a communication environment prediction terminal loaded on a vehicle, making the computer to function as:
a signal receiving unit which receives GPS signals from GPS satellites by using satellite communication;
a position information detecting unit which detects position information indicating a position of the vehicle based on the GPS signals;
a position measurement information generating unit which generates a position measurement information including the position information;
a communication information generating unit which generates communication information indicating a communication environment in an area to which the vehicle moves, based on the position measurement information;
a map information storage unit which stores map information; and
a traveling route calculating unit which calculates a traveling route of the vehicle based on the position information and the map information,
wherein the position measurement information includes a receiving satellite number which is a number of the GPS satellites from which the GPS signals are received, and the position information of the vehicle based on the GPS signals, corresponded with each other,
wherein the communication information generating unit comprises:
an interrupted point setting unit which sets a point, specified by the position information whose receiving satellite number is zero, to a communication interrupted point;
an interrupted section setting unit which sets successive communication interrupted points to a communication interrupted section; and
a communication interrupted route information generating unit which specifies a communication interrupted route by comparing the traveling route with the communication interrupted section and generates communication interrupted route information related to the communication interrupted route, and
wherein the communication information generating unit generates the communication information based on the position measurement information and the communication interrupted route information.

20. A storage medium on which the communication environment prediction program according to claim 19 is stored.

21. A communication environment prediction server capable of communicating with communication environment prediction terminals loaded on plural vehicles, respectively, comprising:
a position measurement information obtaining unit which obtains, from the communication environment prediction terminal, position measurement information including position information indicating a position of the vehicle detected based on GPS signals;
a communication information generating unit which generates communication information indicating a communication environment in an area to which the vehicle moves, based on the position measurement information;
a map information storage unit which stores map information; and
a traveling route calculating unit which calculates a traveling route of the vehicle based on the position information and the map information,
wherein the position measurement information includes a receiving satellite number which is a number of the GPS satellites from which the GPS signals are received, and the position information of the vehicle based on the GPS signals, corresponded with each other,
wherein the communication information generating unit comprises:
an interrupted point setting unit which sets a point, specified by the position information whose receiving satellite number is zero, to a communication interrupted point;
an interrupted section setting unit which sets successive communication interrupted points to a communication interrupted section; and
a communication interrupted route information generating unit which specifies a communication interrupted route by comparing the traveling route with the communication interrupted section and generates communication interrupted route information related to the communication interrupted route, and
wherein the communication information generating unit generates the communication information based on the position measurement information and the communication interrupted route information.

22. A communication environment prediction system comprising communication environment prediction terminals respectively loaded on plural vehicles, and a communication environment prediction server which performs process based on information obtained from the communication environment prediction terminals, the communication environment prediction terminals and the communication environment prediction server capable of communicating with each other,
wherein the communication environment prediction terminal comprises:
a signal receiving unit which receives GPS signals from GPS satellites by using satellite communication;
a position information detecting unit which detects position information indicating a position of the vehicle based on the GPS signals;
a position measurement information generating unit which generates a position measurement information including the position information;
a communication information generating unit which generates communication information indicating a communication environment in an area to which the vehicle moves, based on the position measurement information;
a map information storage unit which stores map information; and
a traveling route calculating unit which calculates a traveling route of the vehicle based on the position information and the map information,
wherein the position measurement information includes a receiving satellite number which is a number of the GPS satellites from which the GPS signals are received, and the position information of the vehicle based on the GPS signals, corresponded with each other,
wherein the communication information generating unit comprises:
an interrupted point setting unit which sets a point, specified by the position information whose receiving satellite number is zero, to a communication interrupted point;
an interrupted section setting unit which sets successive communication interrupted points to a communication interrupted section; and
a communication interrupted route information generating unit which specifies a communication interrupted route by comparing the traveling route with the communication interrupted section and generates communication interrupted route information related to the communication interrupted route,
wherein the communication information generating unit generates the communication information based on the position measurement information and the communication interrupted route information, and
wherein the communication environment prediction server comprises:
a communication information obtaining unit which obtains the communication information from the plural communication environment prediction terminals; and
a prediction information generating unit which generates prediction information predicting the communication environment in a predetermined area, based on the plural communication information obtained by the communication information obtaining unit.

23. A data generating method comprising:
a signal receiving process which receives GPS signals from GPS satellites by using satellite communication;
a position information detecting process which detects position information of a specific area based on the GPS signals;
a position measurement information generating process which generates position measurement information including the position information;
a data generating process which predicts a communication environment in the specific area and generates data indicating the communication environment for each area;
a map information storage process which stores map information; and
a traveling route calculating process which calculates a traveling route of the vehicle based on the position information and the map information,
wherein the position measurement information includes a receiving satellite number which is a number of the GPS satellites from which the GPS signals are received, and the position information of the vehicle based on the GPS signals, corresponded with each other,
wherein the communication information generating process comprises:
an interrupted point setting process which sets a point, specified by the position information whose receiving satellite number is zero, to a communication interrupted point;
an interrupted section setting process which sets successive communication interrupted points to a communication interrupted section; and
a communication interrupted route information generating process which specifies a communication interrupted route by comparing the traveling route with the communication interrupted section and generates communication interrupted route information related to the communication interrupted route, and
wherein the communication information generating process generates the communication information based on the position measurement information and the communication interrupted route information.

24. The data generating method according to claim 23, further comprising:
a predicting process which predicts the communication environment between areas from the data generated by the data generating process.
